(19) United States
(12) Patent Application Publication
(10) Pub. No.: US 2012/0158720 A1
(43) Pub. Date: Jun. 21, 2012

(54) SOCIAL NETWORK POWERED SEARCH ENHANCEMENTS

(75) Inventors: Qing Luan, Sammamish, WA (US); David S. Korn, Sunnyvale, CA (US); Juan Bouvet Mendoza, Issaquah, WA (US); Kimberly M. Vlcek, Redmond, WA (US); Wei Mu, Redmond, WA (US); Sandy Wong, Redmond, WA (US)

(73) Assignee: MICROSOFT CORPORATION, Redmond, WA (US)

(21) Appl. No.: 13/407,947

(22) Filed: Feb. 29, 2012

Related U.S. Application Data
(63) Continuation-in-part of application No. 12/111,309, filed on Apr. 29, 2008.

(51) Int. Cl. G06F 17/30

(52) U.S. Cl. 707/732; 707/E17.108

(57) ABSTRACT

Embodiments of the present invention enhance the search experience of a user by looking at the search history of one or more friends to provide search enhancements to the user. The search enhancements may also be based on information within a user's online social network. Search enhancements based on the user's online social network include identifying people within the user's social network that may have information relevant to a query, posts within the social network that are relevant to the query, and feed items. Examples of search enhancements include an annotation or graphic adjacent to a search result indicating the search result has been visited by one of the user's friends. In another aspect, alternative queries from the friends' search history may be suggested to the user during the search session.

### CROSS-REFERENCE TO RELATED APPLICATIONS

This application is a continuation-in-part of U.S. patent application Ser. No. 12/111,309, filed Apr. 29, 2008, the entirety of which is incorporated by reference herein.

### BACKGROUND

Computer users enter search terms into search engines to find information about various items (e.g., people, sports teams, cities, and companies) or in some case to locate specific objects (e.g. documents, emails, and web pages). The goal of the search engines is to provide the computer users with relevant search results. Internet search engines are a common example of search engine that receive search terms and return search results. Social networks allow people to share thoughts, pictures, updates, and other information with friends in their social network and, in some cases, the general public.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention provide a system and method of using search histories and social network information from a group of friends (alternatively described as friends, social contacts, social network members) to provide an improved search experience for the user. A friend or buddy is a person designated by a user. The person may be designated automatically when the person becomes part of the user's social network. The user's social network may comprise multiple social networks hosted by online social network websites. For example, a user's social network may comprise all of their friends from Facebook®, LinkedIn®, Twitter®, and MySpace®. By designation, the user may cause embodiments of the invention to work with only selected social networks.

Information within the user's social network is leveraged to provide social-network search enhancements. For example, a social pane may be presented as part of a search results page. The social pane displays different categories of information from the user's social network that may be of interest to the user because of a current query or otherwise. For example, the social pane may display people from the user's social network that may be able provide information related to a current query. The social pane may display a group of posts by friends from within the user's social network that are relevant to the query. The posts may be comments made within the social network. The social pane may display activities, such as queries, submitted through the search site. The social pane may display a feed section that includes items from the user's social network feed that are not relevant to the current query, but are selected to be of interest to the user based on what the search engine knows about the user.

Embodiments of the present invention relate to using search histories from one or more buddies to provide more relevant search results and search enhancements that improve the searching experience for the user. In one embodiment, a user submits a search query and is presented with search results and a search enhancement. A search enhancement may be presented adjacent to individual search results and indicate that the search result has been visited by buddies in response to queries similar to the one submitted by the user. In another embodiment, search results visited by buddies are given more weight by the search engine when ranking results or are presented in a separate section of the search results. Buddy search history information may also be used to suggest alternative queries that are related to a query submitted by the user.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is an illustration showing an exemplary computing system architecture suitable for utilizing search information from buddies to enhance a users search experience, in accordance with an embodiment of the present invention;

FIG. 3 illustrates a manner in which relationships between the current query and buddies' queries are analyzed to determine whether search results are related to a query, in accordance with embodiments of the present invention;

FIG. 4 illustrates a method of determining whether a buddy query is related to a current query by categorizing the buddy query and current query, in accordance with embodiments of the present invention;

FIG. 5 illustrates a method of determining whether a buddy query is related to a current query, in accordance with embodiments of the present invention;

FIG. 6 illustrates an additional method of determining whether the current query is related to buddy queries within the buddies' search history, in accordance with embodiments of the present invention;

FIG. 7 illustrates a method of determining whether a current query is related to a search result within the search history by category, in accordance with embodiments of the present invention;

FIG. 8 illustrates a method of determining whether a search result within the search histories of buddies is related to a current query using keywords, in accordance with embodiments of the present invention;

FIG. 9 includes a flow diagram showing an exemplary method for providing search enhancements based in part on buddy search histories, in accordance with embodiments of the present invention;

FIG. 10 includes a flow diagram showing an exemplary method for improving search results using search history from one or more buddies, in accordance with embodiments of the present invention;

FIG. 11 includes an exemplary screen display showing a search input interface, in accordance with embodiments of the present invention;

FIGS. 12-14 include an exemplary screen display showing search enhancements, in accordance with embodiments of the present invention;

FIGS. 15-18 depict a suggested people search enhancement and a series of exemplary interactions with one of the suggested people within the social-search pane, in accordance with an embodiment of the present invention;

FIG. 19 depicts the display of an ask friends post on the user's social network home page, in accordance with an embodiment of the present invention;

FIGS. 20-22 and 26 depict a suggested post search enhancement and a series of exemplary interactions with one of the suggested posts within the social-search pane, in accordance with an embodiment of the present invention;

FIG. 23 includes a flow diagram showing an exemplary method of providing a social-pane search enhancement that displays information from a social network, in accordance with embodiments of the present invention;

FIG. 24 includes a flow diagram showing an exemplary method of providing, on a search results page, search enhancements that are based on a user's social network, in accordance with embodiments of the present invention; and

FIG. 25 includes a flow diagram showing an exemplary method of including information in a social network feed that was generated on a search results page, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Overview

Embodiments of the present invention provide a system and method of using search histories and social network information from a group of friends (alternatively described as buddies, social contacts, social network members) to provide an improved search experience for the user. A friend or buddy is a person designated by a user. The person may be designated automatically when the person becomes part of the user's social network. The user's social network may comprise multiple social networks hosted by online social network websites. For example, a user's social network may comprise all of their friends from Facebook®, LinkedIn®, and MySpace®. By designation, the user may cause embodiments of the invention to work with only selected social networks.

The search histories of these buddies, including related queries and sites visited in response to the related queries, may be used to provide more relevant search results, search enhancements, or suggest alternative search queries drawn from the buddy search histories. In one embodiment, in response to submitting a current query, a user is presented with search results and a search enhancement. A search enhancement may be presented adjacent to individual search results and indicate that the search result has been visited by a buddy. In another embodiment, a search enhancement provides a list of search results that have been visited by buddies and are related to the current query. In another embodiment, related search queries drawn from the buddy search histories are suggested to the user.

Information within the user's social network is leveraged to provide social-network search enhancements. For example, social pane may be presented as part of a search results page. The social pane displays different categories of information from the user's social network that may be of interest to the user because of a current query or otherwise. For example, the social pane may display people from the user's social network that may be able provide information related to a current query. The social pane may display a group of posts by buddies from within the user's social network that are relevant to the query. The posts may be comments made within the social network or activities, such as queries, submitted through the search site. The social pane may display a feed section that includes items from the user's social network feed that are not relevant to the current query, but are selected to be of interest to the user.

Accordingly, in one aspect one or more computer-storage media having computer-executable instructions embodied thereon for performing a method of providing a social-pane search enhancement that displays information from a social network are provided. The method comprises receiving a search query from a user and determining that the user is associated with a social network. The method also comprises generating a relevant friend list comprising friends within the user's social network that have social-network profile information that is responsive to the search query. The method comprises calculating friend-responsiveness ranks for the friends that indicate a responsiveness to the search query and outputting for display on a search results page a threshold amount of the friends selected based on the friend-responsiveness ranks. The method further comprises generating a relevant post list that comprising posts that are responsive to the search query and are associated with friends from the user's social network. The method comprises calculating post-responsiveness ranks for the posts that indicate a responsiveness to the search query. The method also comprises outputting for display on the search results page a threshold amount of the posts selected based on the post-responsiveness ranks. The method also comprises outputting for display on the search results page search results that are responsive to the search query.

Accordingly, in another aspect, a method of providing, on a search results page, search enhancements that are based on a user's social network is provided. The method comprises receiving a search query from a user, accessing the user's social network, and outputting for display search results that are responsive to the search query. The method also comprises outputting for display a first search enhancement that comprises identification information for a friend within the user's social network that is selected because entities within the friend's social network profile are responsive to the search query.

Accordingly, in another aspect, one or more computer-storage media having computer-executable instructions embodied thereon for performing a method of including information in a social network feed that was generated on a search results page are provided. The method comprises receiving, from a search engine, a search result comment that is associated with a social network user identification, the search result comment including text. The method also comprises generating a post that comprises the text for a social network feed associated with the social network user identification and including the post in a feed for a user associated with the social network user identification.

Accordingly, in one embodiment of the invention, a computerized system containing a processor and a computer-storage media for enhancing a search session using buddy search history information is provided. The system includes a search engine that receives a query from a user and generates a plurality of search results that are responsive to the query. The system also includes a search enhancement component that receives information identifying one or more buddies, wherein a buddy is a person designated by the user. The search enhancement component also generates one or more search enhancements that are based on a plurality of buddy search histories associated with the one or more buddies, wherein the plurality of buddy search histories includes at least queries associated with the one or more buddies that submitted the queries and search results associated with the one or more buddies that interacted with the search results. The search enhancement component also causes the one or more search enhancements to be displayed with the plurality of search results.

In another aspect, an embodiment of the invention is one or more computer-storage media having computer-executable instructions embodied thereon for performing a method of providing search enhancements based in part on buddy search histories. The method includes receiving a search query from a user, retrieving a search history for one or more buddies designated by the user, and presenting one or more search enhancements to the user based on the search query and the search history.

A further embodiment of the present invention is directed to one or more computer-storage media having computer-executable instructions embodied thereon for performing a method of improving search results using search history information from one or more buddies. The method includes storing search history information associated with individual users, wherein the individual users may designate a privacy level for the search history information associated with the individual user. The method further includes receiving a search query from a user and receiving information indicating one or more search buddies associated with the user. The method also include displaying one or more additional search queries related to the search query and drawn from a subset of the search history information that is associated with the one or more search buddies, wherein the one or more additional search queries are selectable by the user. The method also includes displaying search results in conjunction with a search enhancement.

Exemplary Operating Environment

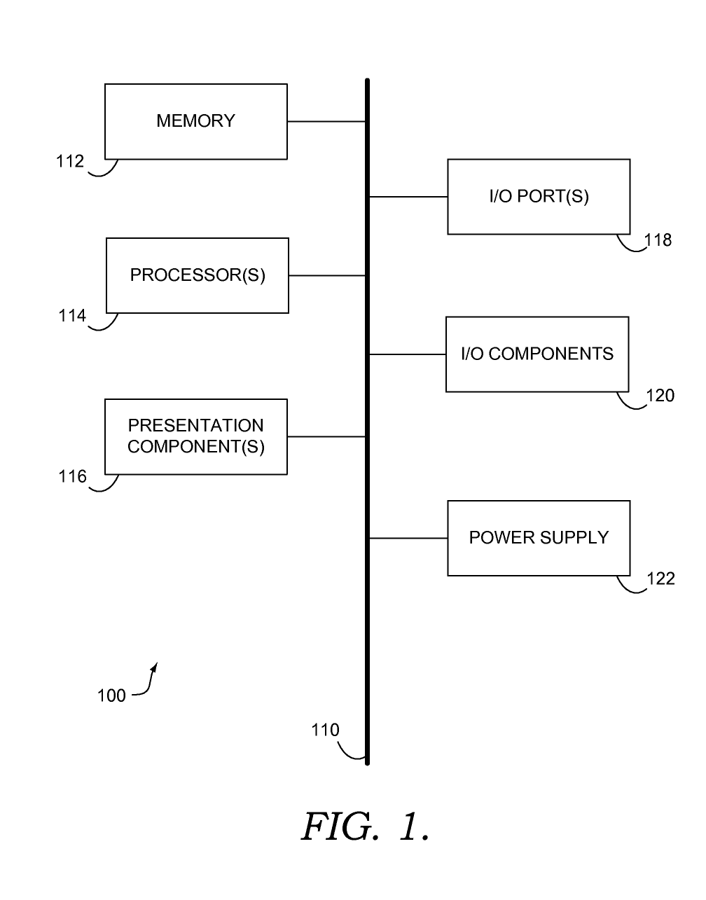

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. The computer-storage media is non-transitory. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

Exemplary System Architecture

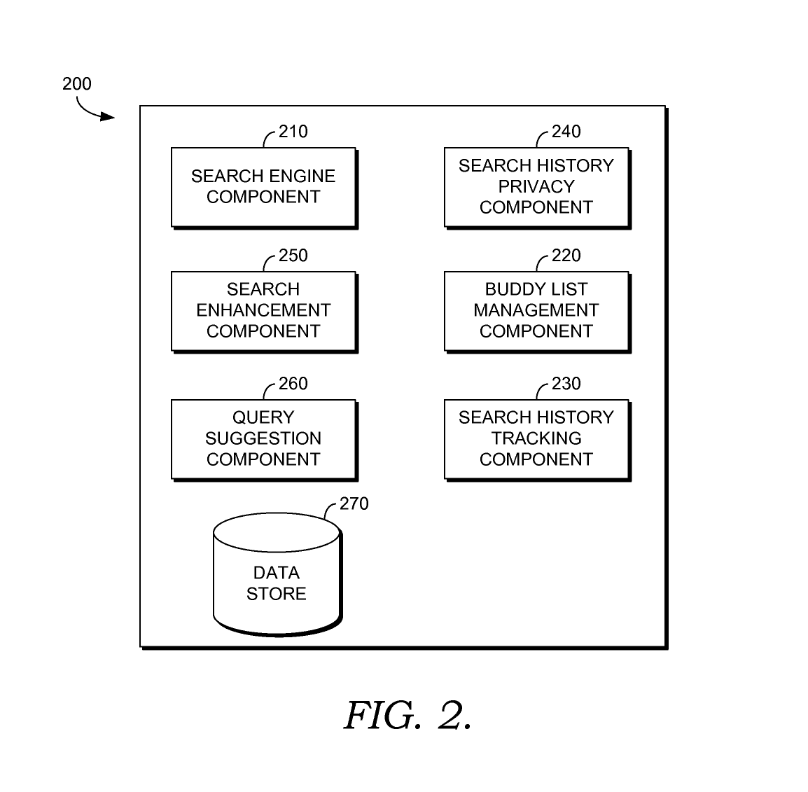

Turning now to FIG. 2, a block diagram is illustrated that shows a system architecture suitable for providing an enhanced search experience that utilizes search history information from one or more buddies. It will be understood and appreciated by those of ordinary skill in the art that the computing system architecture 200 shown in FIG. 2 is merely an example of one suitable computing system and is not intended to suggest any limitation as to the scope of the use or functionality of the present invention. Neither should the computing system architecture 200 be interpreted as having any dependency or requirement related to any single component/module or combination of component/modules illustrated therein.

Computing system architecture 200 includes a search engine component 210, a buddy list management component 220, a search history tracking component 230, a search history privacy component 240, a search enhancement component 250, a query suggestion component 260, and a data store 270. Computing system architecture 200 may reside on a single computing device, such as computing device 100 shown in FIG. 1. In the alternative, computing system architecture 200 may reside in a distributed computing environment that includes multiple computing devices coupled with one another via one or more networks. Such networks may include, without limitation, one or more local area networks (LANs) and/or one or more wide area networks (WANs). Such network environments are commonplace in offices, enterprise-wide computer networks, intranets, and the Internet. Accordingly, the network, or combination of networks, is not further described herein.

The search engine component 210 receives a search query and returns search results. In one embodiment, the search query is received over the Internet and the search results are web pages connected to the Internet. The search engine component 210 may include a web crawler that indexes web pages or other documents to aide in the process of quickly finding and presenting relevant search results. The search engine component 210 may apply an algorithm to determine which search results are the most relevant. The list of results produced or returned in response to a search query may be called the search engine results page or SERP.

Buddy list management component 220 performs several functions related to buddy lists, including creating, deleting, and storing buddy lists. A buddy list is a group of people designated by an individual user as buddies. A buddy list could be a user's contact list or a user's social network. In one embodiment, the individual users and people on the user's buddy list must all subscribe to or sign up for a search service. In one embodiment, the buddy list may be unilaterally established by a user. In other words, the people placed on the buddy list do not need to give consent to be added to a user's buddy list. In another embodiment, the buddy relationship is bilateral meaning that a person must consent to being placed on a user's buddy list.

The buddy list management component 220 may facilitate the creation of buddy lists. The buddy list management component 220 may allow users to edit the buddy list by adding buddies to and/or subtracting buddies from the list. The buddy list management component 220 may provide an interface to allow the user to input identification information (e.g. name, email address, user ID) for buddies. The buddy list management component 220 may also suggest buddies from a list for selection by the user. In a case where consent of a potential buddy is required to add them to a buddy list, the buddy list management component 220 may contact the potential buddy to obtain the necessary consent from the buddy.

The search history tracking component 230 facilitates the collection of search history information for individual users. The search history tracking component 230 may store search history by search contexts. A search context may include a query submitted by a user, the search results presented to the user in response to the query and those search results selected and viewed by the user in response to the query. The search results selected and viewed by the user may include more than just search results returned in the search engine result page (SERP). The search context information may include all content browsed from a search query. In addition, privacy information may be included in the search context that grants different levels of access to different users or buddies (as will be described in more detail below with reference to the search history privacy component 240). All of the information in an individual search context is associated with the user who submitted the search query. Several methods of identifying a user exist that allow the search history tracking component 230 to attribute the search context to the proper user. For example, an individual user may be identified by asking the user to login, enter an email address or entering some other identification information. In another embodiment, the user is identified by an IP address or through a cookie on the user's computer. In another embodiment, the search history information is collected by a client device that is used by the user during a search session. Thus, the client device may identify the user and send the search history information along with information identifying the user to a central data store. Other methods of identifying the user are also possible. In one embodiment, search history for a user is retrieved from a browser and used to populate the search history for the user. The retrieval of search history information from a browser may occur the first time the search history tracking component 230 interacts with a user, or as an ongoing way to collect search history information from the user.

An individual user may generate several search contexts during a search session. A search session starts when a user enters the search engine and stops when the user exits the search engine. A new search context may be generated every time a new query is submitted by the user. In one embodiment, the search history tracking component 230 facilitates storing search history information in data store 270.

The search history privacy component 240 collects privacy preferences and associates them with search contexts. In one embodiment, the search history privacy component 240 allows a user to designate a privacy level for each search context generated during a search session. In another embodiment, the user may designate a privacy level that is assigned to all search contexts generated during a search session. In another embodiment, a user selects a default privacy level that is assigned to all search contexts generated until the default privacy level is changed, or an individual privacy level is selected for a search session or a search context. The search history privacy component 240 may allow a user to designate a privacy level as a search query if submitted. The search history privacy component 240 may also allow a user to view their search history and assign or change the designated privacy level at any level of granularity. For example, the user could change the privacy level on a search context basis, a session context basis, or the entire search history.

The search history privacy component 240 may assign one of several privacy levels to a search history, or part of a search history. Different privacy levels may be designated for different parts of a user search history. In one embodiment, one of five different privacy levels are assigned to a user's search history or parts of the search history. The five privacy levels include a private designation, an individual buddies designation, an all buddies designation, a buddy group designation, and a public designation. The private designation indicates that the search context should not be shared with others or used in any way to enhance search results. The individual buddies designation indicates individual buddies that can use the search context to enhance a search. The all buddies designation indicates that all of the buddies on the users buddy list may use the search context to enhance a search. The buddy group designation indicates that one or more groups of buddies may use the search context to enhance a search. A public designation indicates that all users and buddies on a system may use the search context to enhance a search. The search history privacy component 240 may provide any number of interfaces to facilitate the collection of privacy level information.

The search enhancement component 250 provides search enhancements in response to a search query submitted by a user. The search enhancement utilizes search history information from one or more buddies of the user submitting the search query. In some embodiments, search history from all buddies included in the user's buddy list is used to provide search enhancements. An interface may be provided for the user to select an individual buddy, a group of buddies, a predefined group of buddies, or all buddies to provide a search enhancement. For example, a user could predefine a group of buddies consisting of hunting enthusiasts. When submitting a search query related to hunting, the user may wish to designate this predefined group to provide a search enhancement. The purpose of the search enhancement is to leverage the buddies' search experience to provide information regarding the relevance of search results presented to the user.

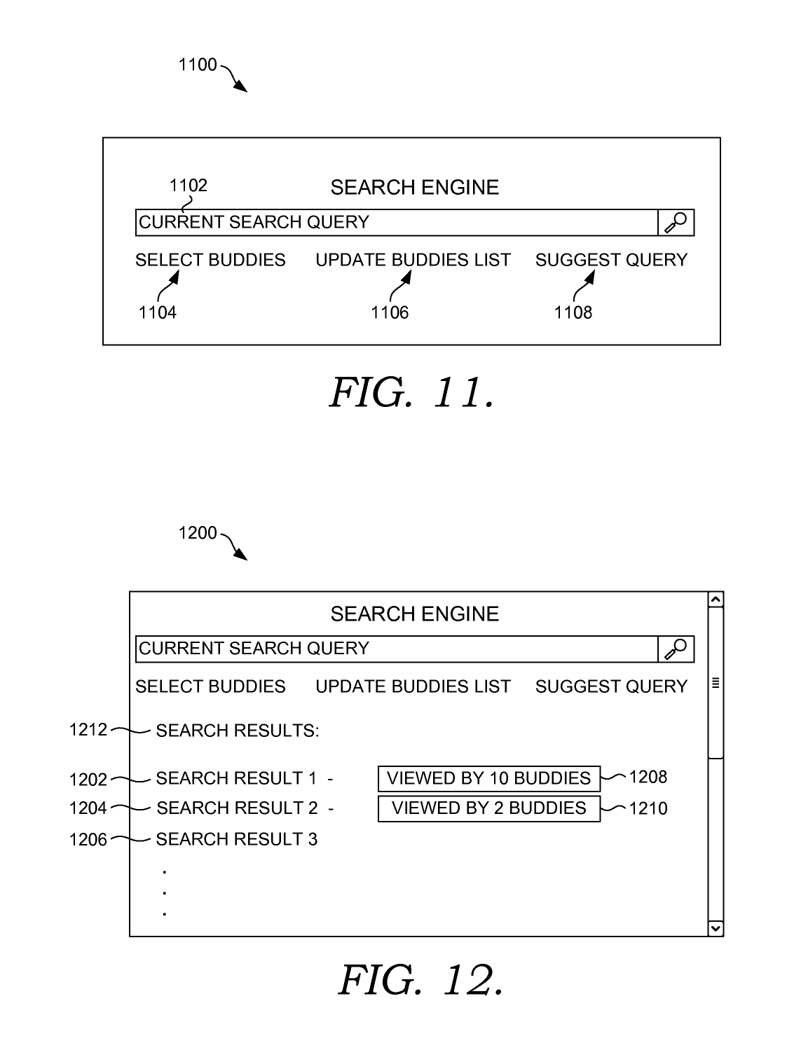

Many different kinds of search enhancements may be presented to a user. In one embodiment, the normal search results are presented in conjunction with a search enhancement that indicates an individual search result has been visited by a buddy. Normal search results are the search results returned by the search engine without taking the buddy search histories into account. The indication may list a specific buddy who selected and viewed a search result, the number of buddies that selected and viewed a search result, or just that at least one buddy selected and viewed a search result. In one embodiment, the search enhancement is a graphic that is displayed adjacent to an individual search result that is described by the graphic. FIGS. 11-14 illustrate various embodiments of a search enhancement. These embodiments are shown for the sake of example and are not meant to be limiting.

FIG. 11 depicts an illustrative screen display showing a search input interface 1100 that may be provided, for instance, via a search engine web page. The search input interface 1100 allows a user to input a current search query 1102. A user may select one or more buddies by selecting the select buddies link 1104. A user may update their buddy list by adding buddies to their buddy list and/or deleting buddies from their buddy list through the update buddies list link 1106. The user may solicit alternative queries that are related to the current query by selecting the suggest query link 1108. As described previously, the suggested queries could be taken from the search history of one or more buddies.

FIG. 12 depicts an illustrative screen display 1200 showing a search enhancement that indicates how many buddies have visited a particular search results. The search results section 1212 includes search result 1202, search result 1204, and search result 1206. In one embodiment, each of these search results is returned by the search engine without taking the buddy search history information into account. Search enhancement 1208 is displayed adjacent to search result 1202 and indicates that search result 1202 has been visited by 10 buddies. Search enhancement 1210 is displayed adjacent to search result 1204 and indicates that search result 1204 has been visited by two buddies. Notice that a search enhancement is not provided for search result 1206 illustrating that search results can be presented without a search enhancement.

In one embodiment, the normal search results (i.e. those returned without taking the buddies' search history into account) are re-ordered based on information from the search history, such as the number of times a search result has been selected and viewed by buddies. The re-ordered search results may be presented with or without other search enhancements. FIG. 12 shows search results 1202, 1204, and 1206 ordered according to the number of times they have been visited by one or more buddies. Search result 1202 is listed first because it has been visited by 10 buddies. Search result 1204 is listed second because it has been visited by two buddies. Search result 1206 is listed third because it has not been visited by any buddies. Search results, such as search result 1206, that have not been viewed by buddies may be ranked according to typical ranking mechanism used by the search engine.

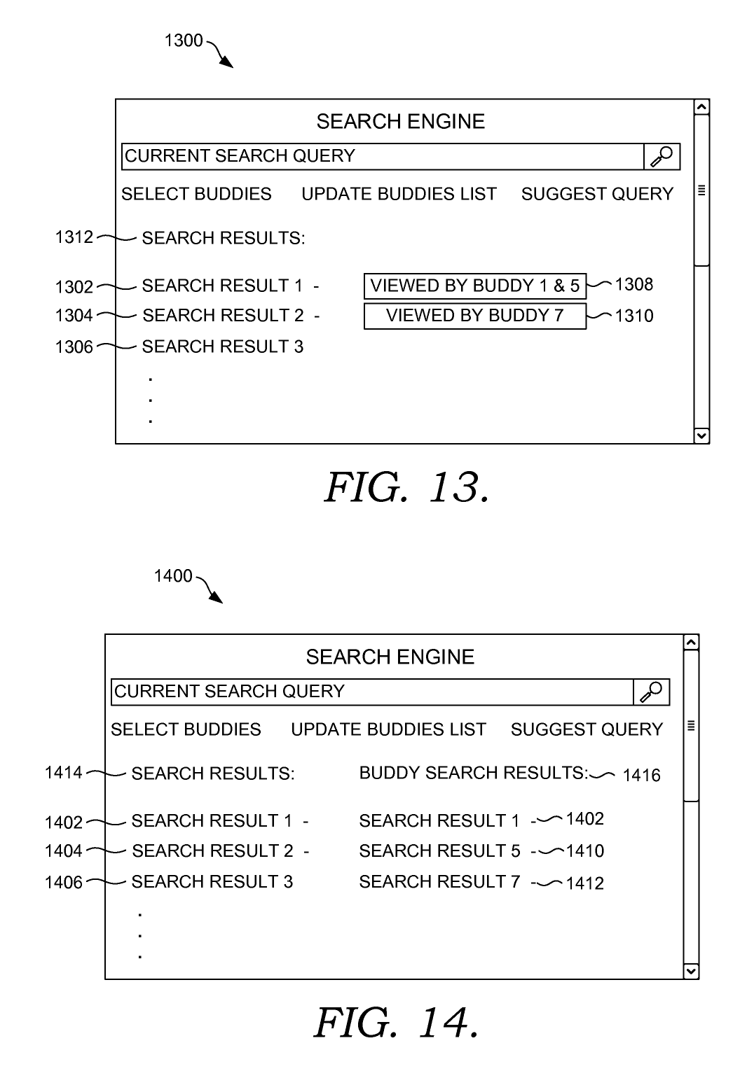

FIG. 13 depicts an illustrative screen display 1300 showing a search enhancement that indicates which buddies have visited a particular search result. The search results section 1312 includes search result 1302, search result 1304, and search result 1306. In one embodiment, each of these search results is returned by the search engine without taking the buddy search history information into account. Search enhancement 1308 is displayed adjacent to search result 1302 and indicates that search result 1302 has been visited by buddy 1 and buddy 5. Search enhancement 1310 is displayed adjacent to search result 1304 and indicates that search result 1304 has been visited by buddy 2. Notice that a search enhancement is not provided for search result 1206 illustrating that search results can be presented without a search enhancement.

FIG. 14 depicts an illustrative screen display 1400 showing a search enhancement that provides a separate section of search results that include results selected and visited by buddies. The search results section 1414 includes search result 1402, search result 1404, and search result 1406. In one embodiment, each of these search results is returned by the search engine without taking the buddy search history information into account. The buddy search results section 1416 displays one or more search results that are have been visited and selected by one or more buddies and are related to the current search query. The buddy search results section 1416 includes search result 1402, search result 1410, and search result 1412. Search result 1402 is listed in both sections indicating that a search result may appear in both sections if it meets the respective criteria for inclusion in each search result section.

When providing the search enhancement, the privacy level of search context information submitted by the buddies will be honored. For example, if a buddy has been designated by a first user, but does not have any search history available to the first user because of privacy levels assigned to the search history information then that buddy's search history information will not be used to provide a search enhancement. In some instances, the privacy level assigned to search information that appears in multiple contexts may be in conflict. A conflict in the search history information can occur when the same search result is viewed in response to two different queries because each query is part of a different search context and each search context may be assigned a different privacy level. For example, a search result visited in one context in response to a first query may be designated private, whereas the same search results visited in a second context in response to a second query may be designated as public. In one embodiment, the conflict is resolved by utilizing the search history information at the lowest privacy level. The lowest privacy level is the level that allows the most information to be used. In another embodiment, the conflict is resolved by ascribing the highest privacy level to the conflicting search history information. In the embodiment where the lowest privacy level is used, the search result will be used to enhance the buddies' search. For example, if in response to a query regarding cars, a buddy visits a consumer advocacy site and designates that search context containing the query and the consumer advocacy site as public and then visits the consumer advocacy site in response to a second query that is designated private, the consumer advocacy site would nevertheless be utilized by the search enhancement component 250 to generate a search enhancement. On the other hand, the opposite result will occur if the highest privacy level governs the conflict in privacy levels. In that case, the consumer advocacy site would not be utilized by the search enhancement component 250 to generate a search enhancement because it is part of a search context designed as private.

The search enhancement component 250 may provide other search enhancements such as reordering the search results based on giving more weight to search results viewed by one or more buddies. In another embodiment, a separate group of search results that have been visited by buddies and that are related to the submitted query are presented in a separate section. In yet another embodiment, the search enhancement includes interacting with the search engine to adjust the relevant weight given to search results visited by buddies.

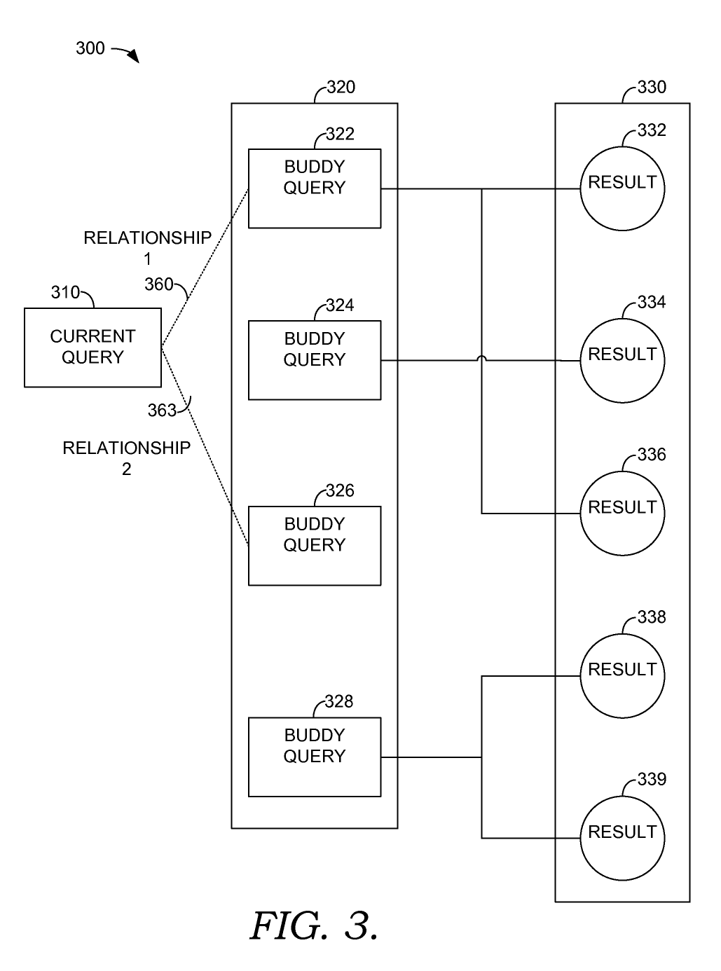

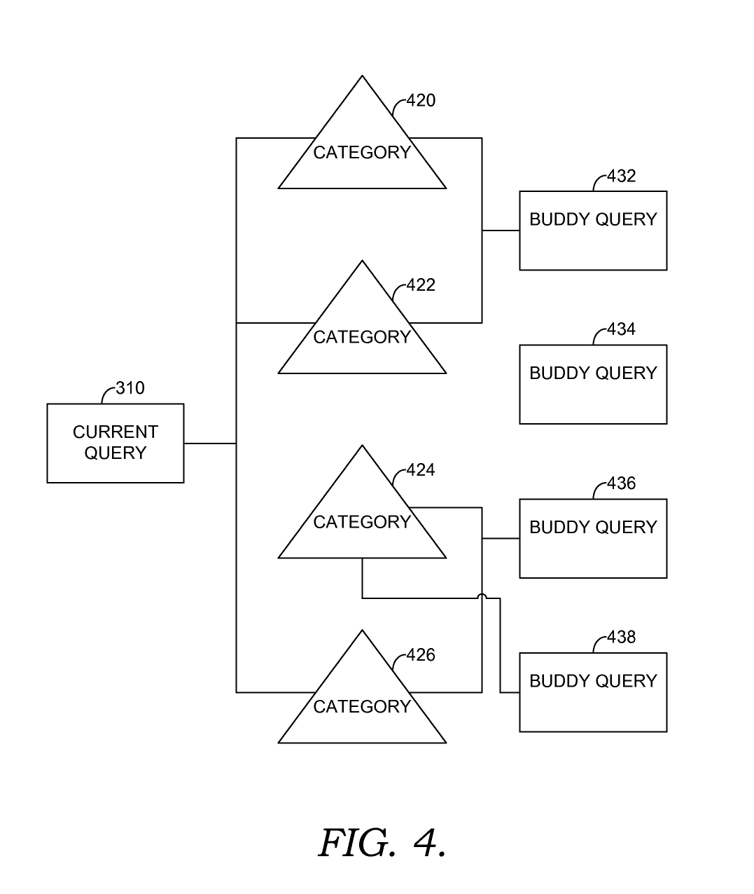

An important aspect of providing a search enhancement includes determining which search results and queries within a buddies' search history are related to the current query submitted by the user. FIG. 3 and FIGS. 7-8 illustrate determining whether a search result within the search history is related to the current query. FIGS. 4-6 illustrate determining whether a buddy query is related to the current query. The examples shown in FIGS. 3-8 are for the sake of illustration only, and are not meant to be limiting. Other methods of determining whether a relation ship exists between the current query and a buddy query or the current query and a buddy search result are possible.

FIG. 3 illustrates a manner in which relationships between the current query and buddies' queries from the search history are analyzed to determine whether search results are related to the current query in accordance with embodiments of the present invention. The analysis illustrated in FIG. 3 determines that a search result is related to a current query if the search result was selected and viewed by a designed buddy when the search result was presented in response to a buddy query that is related to the current query. FIG. 3 shows a current query 310 submitted by the user. FIG. 3 also shows a buddy query group 320 including a group of queries submitted by buddies, and buddy result group 330 including search results visited by the buddies in response to the various buddy queries. Buddy query group 320 and buddy search result group 330 are taken from the search histories for the user's buddies. Buddy query group 320 includes buddy query 322, buddy query 324, buddy query 326, and buddy query 328. Only four buddy queries are shown for the sake of illustration, but many more buddy queries could be includes. Buddy search result group 330 includes search result 332, search result 334, search result 336, search result 338, and search result 339. As with the buddy queries, the search results are taken from the buddies' search histories and could include many more search results than the five shown. Current query 310 is related to buddy query 322 through relationship 360. Buddy query 326 is related to current query 310 through relationship 363. The various methods of determining whether a relationship between the current query 310 and a buddy query are described subsequently. In one embodiment, search result 332 and search result 336 would be related to the current query 310 because they were visited by a buddy in response to buddy query 322 which is related to the current query 310. The search results visited only in response to buddy query 324 and buddy query 328 may not to be related to current query 310 since buddy query 324 and buddy query 328 are not related to the current query. Thus, in this embodiment, only search result 332 and search result 336 would be determined to be related to current query 310.

Turning now to FIG. 4, a block diagram illustrates determining whether a buddy query is related to a current query by categorizing the query, in accordance with embodiments of the present invention. In this embodiment, a buddy query is related to the current query 310 if it falls within one or more of the same categories. A category may be a designation assigned to a search result or query based on the subject matter of the search result or query. Both search results and queries may be assigned categories to help present relevant search results in response to a query. FIG. 4 includes current query 310 category 420, category 422, category 424, and category 426. The lines between the current query 310 and category 420, category 422 and category 426 indicate that the current query 310 is categorized into these three categories. The current query 310 does not fall into query category 424, as indicated by the lack of a connection. FIG. 4 also includes buddy query 432, buddy query 434, buddy query 436, and buddy query 438. Buddy query 432 is related to current query 310 because they have at least one category in common. In this case, they are both in category 420 and category 422. Buddy query 434 is not related to current query 310 because it is not related to category 420, category 422, or category 426. Buddy category 436 is related to current query 310 because they are both in category 426. In one embodiment, the fact that buddy query 436 is also categorized in category 424 which is not related to the current query 310 does not prevent it from being related to the current query 310. Buddy search query 438 is not related to the current query 310 because it is not related to one of the categories to which current query 310 is related.

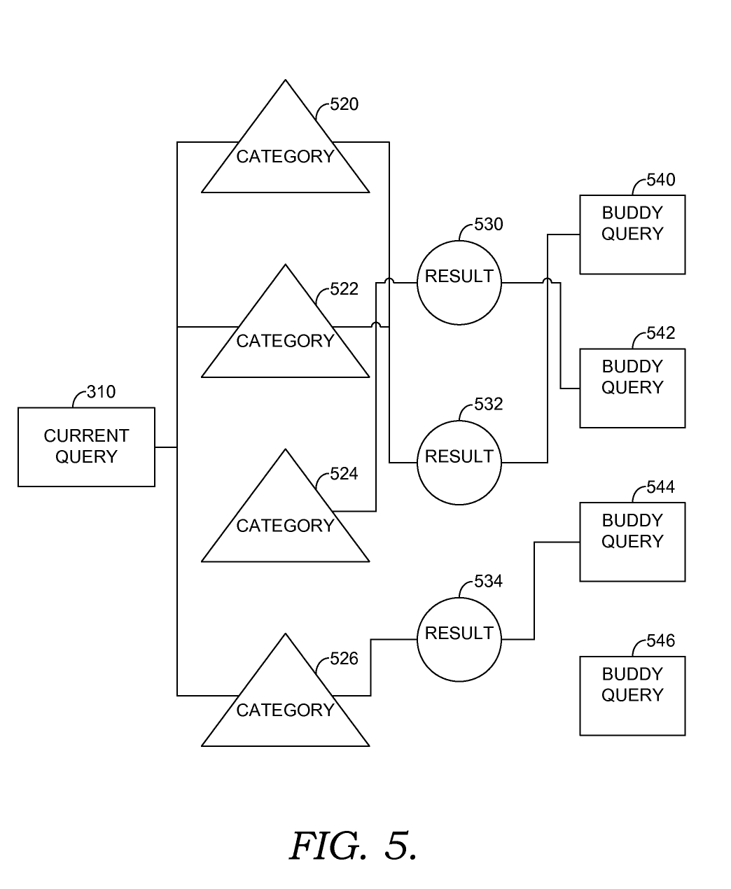

Turning now to FIG. 5, a block diagram illustrates determining whether a buddy query is related to a current query, in accordance with embodiments of the present invention. In this embodiment, buddy queries are determined to be related to the current query 310 if the buddy query produces at least one search result that is in the same category as the current query 310 and that was visited by at least one buddy in response to a buddy query. FIG. 5 includes current query 310. FIG. 5 also includes category 520, category 522, category 524, and category 526. FIG. 5 also shows search result 530, search result 532, and search result 534. In one embodiment, all search results within the search histories of buddies that fall within categories assigned to the current query 310 may be included in the evaluation. FIG. 5 also includes buddy query 540, buddy query 542, buddy query 544, and buddy query 546. The lines between the current query 310 and categories indicate that the current query 310 is categorized into the category to which it is connected. Thus, the current query 310 is categorized into categories 520, 522, and 526, but not category 524. The lines between search results and categories indicate that the search result is in the category or categories to which it is connected. Thus, search result 530 is in category 524, search result 532 is in category 520 and 522, and search result 534 is in category 526. The lines between search results and buddy queries indicate that the search result was visited by a buddy in response to the query to which the search result is connected. Thus, search result 530 was visited in response to buddy query 542, search result 532 was visited in response to buddy query 540, and search result 534 was visited in response to buddy query 544.

Continuing with FIG. 5, buddy queries are determined to be related to the current query 310 if the search results visited in response to the buddy query are in the same category as the current query 310. For example, buddy query 540 is related to the current query 310 because search result 532, which shares category 520 with current query 310, was visited in response to buddy query 540. Similarly, buddy query 544 is related to current query 310 because search result 534, which shares category 526 with current query 310, was visited in response to buddy query 544. Conversely, buddy query 542 is not related to current query 310 because search result 530 is only in category 524, which is not shared with current query 310. Buddy query 546 is unrelated to any of the search results and, thus, is not related to current query 310.

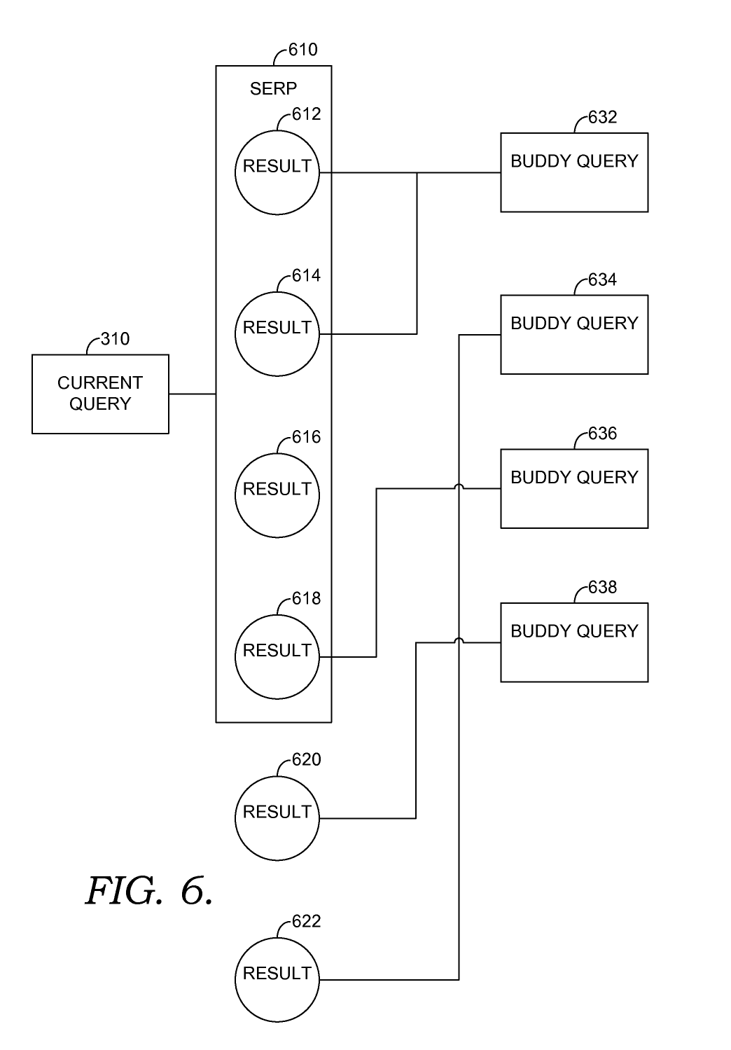

Turning now to FIG. 6, a block diagram illustrates determining whether the current query is related to buddy queries within the buddy search history, in accordance with an embodiment of the present invention. In this embodiment, buddies' queries are related to the current query 310 if they returned one or more search results that are also within the search engine results page (“SERP”) 610 for the current query 310. The SERP 610 includes search results returned by the current query 310 without use of the buddy search history information. FIG. 6 includes current query 310 and a group of search results within the SERP 610. The search results within SERP 610 include search result 612, search result 614, search result 616, and search result 618. Search result 620 and search result 622 are also shown but they are not within SERP 610. FIG. 6 also includes buddy query 632, buddy query 634, buddy query 636, and buddy query 638. The lines between buddy search query 632 and search results 612 and 614 indicate that search results 612 and 614 selected by a buddy in response to buddy query 632. The line between buddy search query 634 and search result 622 indicates that search result 622 was selected by a buddy in response to buddy query 634. The line between buddy search query 636 and search result 618 indicates that search result 618 was selected in response to buddy query 636. The line between buddy search query 638 and search result 620 indicates that search result 620 was selected in response to buddy query 638.

Continuing with FIG. 6, buddy query 632 is related to current query 310 because it resulted in the selection of search results 612 and 614, both of which are in the SERP 610. Similarly, buddy query 636 is related to current query 310 because it resulted in the selection of search result 618, which is in the SERP 610. Buddy query 634 and buddy query 638 are not related to current query 310 because search results within SERP 610 were not visited in response to either buddy query 634 or buddy query 638.

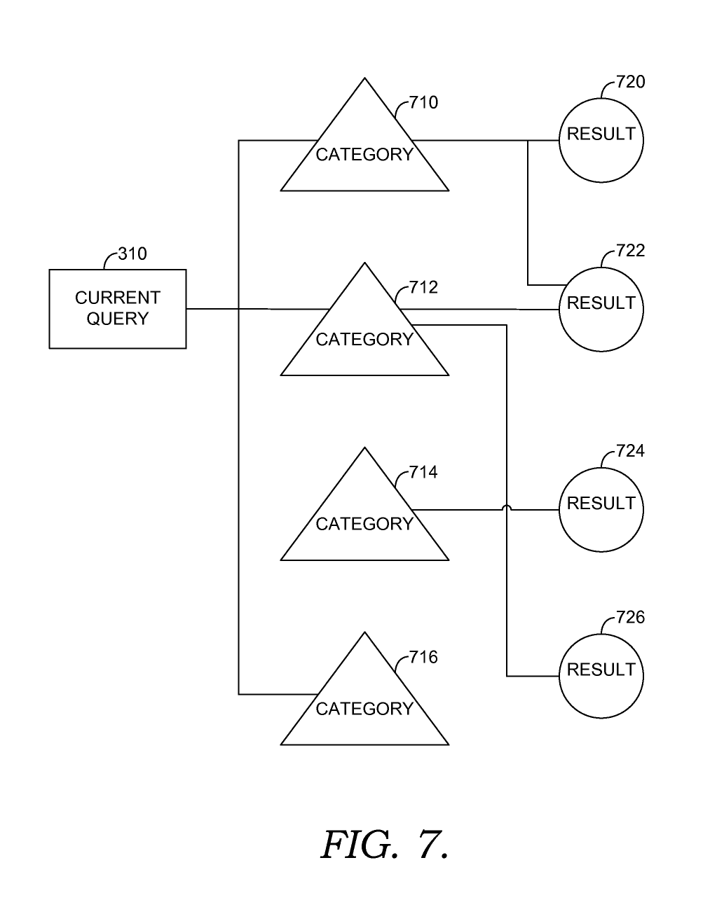

Turning now to FIG. 7, a block diagram illustrates determining whether a current query is related to a search result within the buddies' search history using categories, in accordance with an embodiment of the present invention. In FIG. 7, a buddy search result is related to the current query 310 if they have a category in common. FIG. 7 includes current query 310. Current query 310 falls into category 710, category 712 and category 716 as indicated by connecting lines. Current query 310 does not fall into category 714. Search result 720, search result 722, search result 724, and search result 726 are all found within the search histories of the user's buddies. Search result 720, search result 722, and search result 726 all fall into a category in common with the current query 310. Search result 724 falls under category 714, which is not related to current query 310. Accordingly, search result 724 is not related to the current query 310. Thus, only search result 720, search result 722, and search result 726 are related to the current query 310.

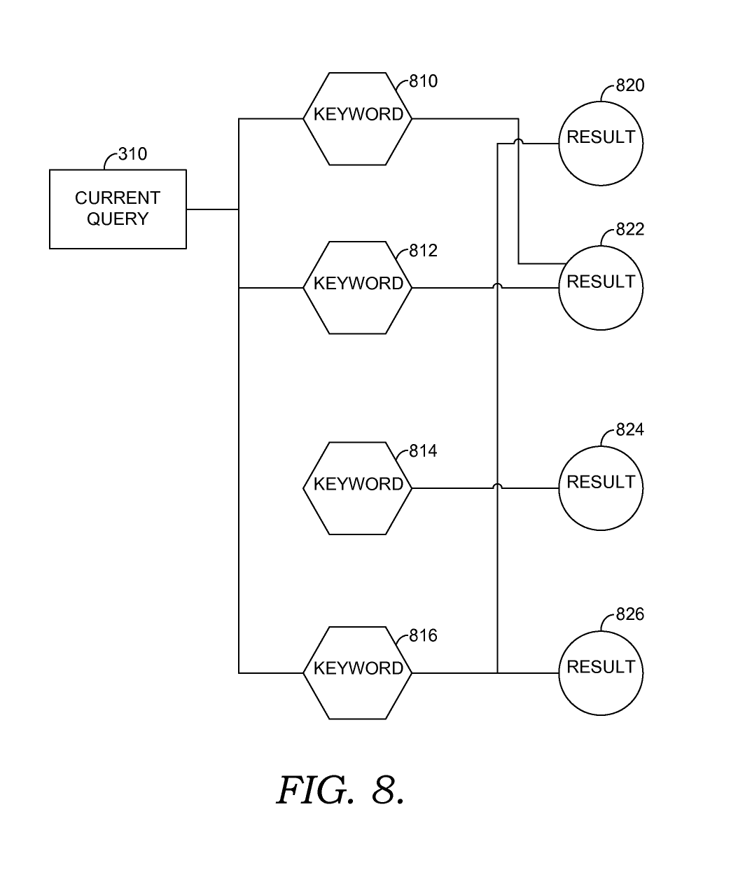

Turning now to FIG. 8, a block diagram illustrates determining whether a search result within the search histories of buddies are related to a current query using keywords, in accordance with embodiments of the present invention. Examples of keywords include a single word, multiple words, a clause, a sentence, numbers, and combinations of letters and numbers. In FIG. 8, the current query 310 is related to a buddy search result if they have a keyword in common. A keyword may be assigned to, or found within, a search result or query based on the subject matter of search result or query. In one embodiment, a list of keywords is assembled and assigned to a query or search result if the keyword occurs in the search result or query. FIG. 8 shows that current query 310 includes keyword 810, keyword 812, and keyword 816. Keyword 814 is shown for the sake of illustration but is not contained in current query 310. Search result 820, search result 822, search result 824, and search result 826 are all found within the search histories of buddies designated by the current user. Search result 820 is related to current query 310 because it also contains keyword 816. Search result 822 is related to the current query 310 because it contains keyword 810, and keyword 812. Search result 824 is not related to current query 310 because it is only related to keyword 814, which is not related to current query 310. Search result 826 is related to current query 310 because it contains keyword 816.

Returning now to FIG. 2, the search enhancement component 250 may utilize the methods of FIGS. 3-8, or other methods to determine that a search result within the buddy search history is related to the current query. In one embodiment, a search result from the search history information must also be in the SERP for the current query to be considered related. In other embodiments, the search result from the search history information does not need to be in the SERP for the current query. Having made this determination, search enhancements may be presented in association with the related search results as described previously.

The query suggestion component 260 identifies related queries within the buddy search histories and presents the related queries to the user as alternative query suggestions to allow the user to refine the search. The query suggestion component 260 may use the approaches described with reference to FIG. 3, FIG. 4, FIG. 5, FIG. 6, or another approach to determine whether a query within the buddy search history is related to the current query. Variations on the described methods as well as other methods not explicitly described may also be used. The query suggestions may be presented prior to presenting search results. The alternative query suggestions may also be presented after search results are presented.

Data store 270, may store information for the search engine, search histories, buddy lists, and any other information necessary to enable the functions of computing system architecture 200. In one embodiment, data store 270 organizes the information in a relational data base. Data store 270 may be centrally located and communicatively connected to other components operating on different computing devices.

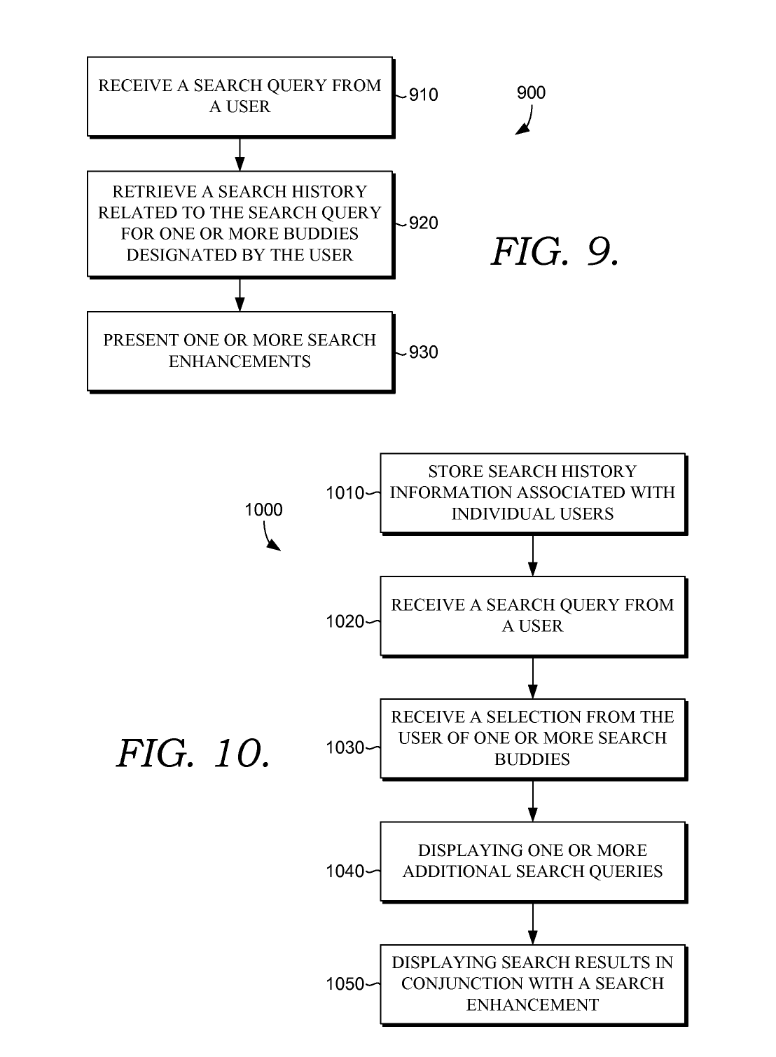

Referring next to FIG. 9, a flow diagram showing an exemplary method for providing search enhancements based in part on buddy search histories is shown and designated generally as reference numeral 900. At step 910, a search query is received from a user. In one embodiment, a search query is submitted over the Internet through a user interface intended to receive search queries. For example, a search query may be submitted in the query field present on an Internet web page. The query may be a single word, or a series of words. The query may also contain Boolean operators. Embodiments of the present invention are not intended to be limited by the type of query received or the manner in which the query is received.

At step 920, a search history for one or more buddies designated by the user is retrieved. In one embodiment, the buddies are designated through a user interface displayed to the user. In one embodiment, a single buddy is designated. In another embodiment, two or more buddies are designated. In another embodiment, a predetermined group of buddies is designated by the user. The buddies may be selected from a list of buddies that was previously created by the user. In another embodiment, the buddies may be entered in conjunction with the search query. In yet another embodiment, all buddies on a user's list may be used. A search history may be stored in a data store that is communicatively connected to the computing device retrieving the search history. As explained above, the search history may be stored in terms of search contexts that each includes a search query, search results visited by the buddy submitting the search query, and a privacy level. Other information may also be stored in a search context. Each individual search context should be associated with a single user making it possible to retrieve search histories for only one or more designated buddies.

At step 930, one or more search enhancements are presented to the user. The search enhancements are generated based in part on the search query and the retrieved search history. In one embodiment, a search enhancement includes an annotation displayed adjacent to an individual search result. As illustrated in FIG. 12, the annotation may communicate the number of buddies that have viewed the individual search result. As illustrated in FIG. 13, the annotation may identify one or more buddies that have actually viewed the search result. In yet another embodiment, the annotation may simply indicate that at least one buddy has viewed the individual search result. As illustrated in FIG. 14, the search enhancement may include a separate section of search results that have been viewed by one or more buddies and are related to the search query. Some methods of determining whether a search result is related to a current query have been described previously. In another embodiment, the search enhancement includes reordering the search results returned from the query by giving additional weight to search results with the SERP that were visited by a buddy. This ensures that search results visited by buddies will be considered more relevant than search results that have not been visited by buddies.

In one embodiment, one or more additional search queries related to the current search query may be presented to the user for selection as a query suggestion to refine the user's search. The additional queries may be drawn from the search histories of the one or more designated buddies if it is determined to be related to the originally submitted search query. Some methods of determining whether a query within the search histories of designated buddies is related to the current query have been described previously.

A privacy input interface may be presented to the user in conjunction with the search engine results page or any other time during a search session. The privacy input interface allows the user to select a privacy level for each search context associated with the user. As described previously, a search context may include an individual query, search results viewed by the user submitting the individual query, and privacy information. In one embodiment, privacy level information is received through the privacy input interface presented to the user. The privacy level information may then be stored in association with the search context in a data store that is used to store the search context information. Various privacy levels that may be used have been described previously.

Turning now to FIG. 10, a flow diagram showing an exemplary method for improving search results using search history information from one or more buddies is shown and designated generally with reference to numeral 1000. At step 1010, search history information associated with individual users is stored. The individual users may designate a privacy level for the search history information associated with the individual user. Methods of assigning privacy levels to various parts of a user's search history have been described previously as have various privacy levels.

At step 1020, a search query is received from a user. Various embodiments of receiving a search query for a user have been described previously with reference to FIG. 9. At step 1030, identification information for one or more search buddies associated with the user is received. At step 1040, one or more additional search queries related to the search query and drawn from a subset of the search history information that is associated with the buddies are displayed to the user. As described previously, the one or more search queries may be selected by the user. Upon selection of a related search query, results associated with that search query will be presented to the user. At step 1050, the search results normally returned from the original search query are presented in association with one or more search enhancements. Examples of possible search enhancements have been described previously with reference to FIGS. 11-14 and elsewhere.

Social-Pane Search Enhancement

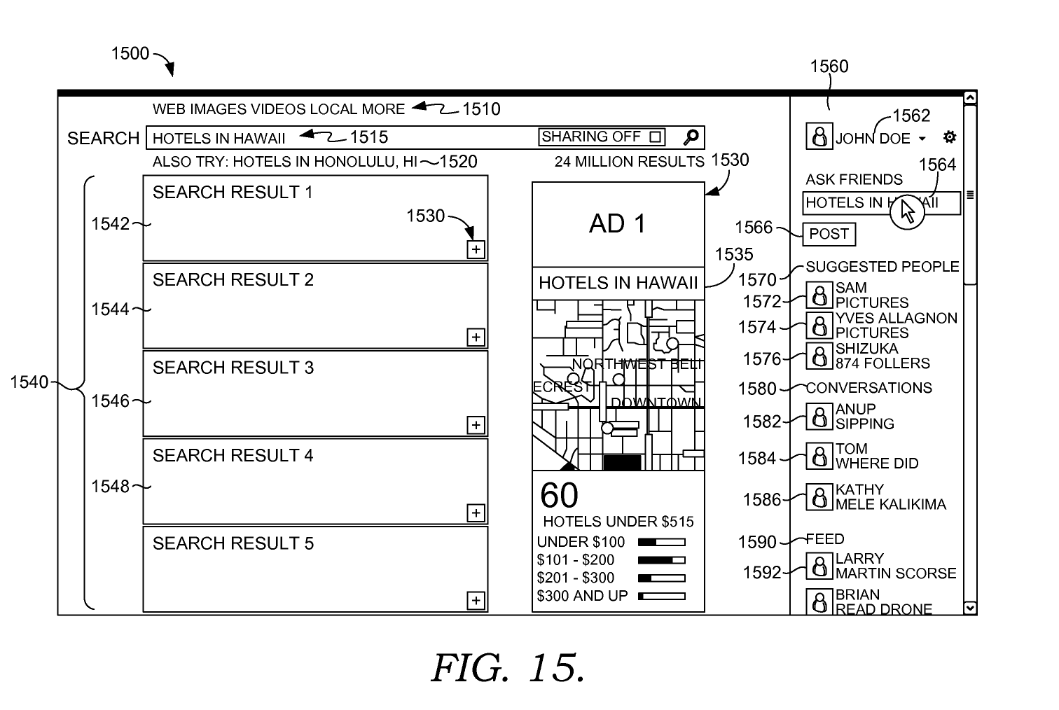

Turning now to FIGS. 15-23, a social pane displayed on a search results page is illustrated according to embodiments of the present invention. FIG. 15 shows the search result page 1500 shortly after a user submitted the query 1515 “Hotels in Hawaii.” The search results page 1500 includes a vertical selection menu 1510 where the user can select a category to search. The search results page 1500 also includes an alternative-query suggestion section 1520 that displays popular queries that are similar to the submitted query.

The search results page 1500 includes a search results section 1540. The search-results section 1540 includes search results 1542, 1544, 1546, and 1548. Each search result includes a search-comment button 1550. The search-comment button 1550 allows a user to comment on a search result. The comment may be automatically uploaded to the user's social network. As mentioned, the user's social network may comprise one or more social websites in which the user participates. The user may specify the social networks they wish to link with their search activity. The search results within the search-results section 1540 may include the search enhancements described previously, including friend search histories.

The search results page 1500 also includes an advertisement 1530 and geographic-presentation section 1535. The geographic-presentation section 1535 shows entities surfaced through the search results on a map. In this case, the geographic-presentation section 1535 shows the hotel locations.

The search results page 1500 includes a social pane 1560. The social pane 1560 displays several social searching features. Social searching allows the user to leverage information within their social network to help them gain information relevant to their search session. Generally, a search session comprises one or more queries related to a single topic or task, such as finding travel information for a planned vacation.

A user may opt-in to social searching through an interface accessed through a search website. The user may need to provide their user name and password for any social websites they wish to link to their social searching experience. Once the user has opted-in and linked various social websites, the search engine will exchange information with the social websites to enhance the user experience on the social website as well as on the search page.

The profile selection box 1562 allows a user to select one or more of their social networks to be associated with a current query. In one embodiment, profile selection box 1562 includes a profile picture and user name from the selected social network. While shown as a dropdown selection box, multiple social networks could be selected using radio buttons or other selection methods.

The ask friends interface 1564 allows a user to post a question or comment on one or more of their selected social networks. The user's friends or friends on their social network can then respond to help the user find relevant information. As can be seen, the ask friends interface 1564 is initially populated with the search query. The user may navigate to the ask friends interface 1564 and provide additional commentary that is then displayed on the user's social network feed and displayed on the feeds of the user's friends. The user may post the question to their social network by selecting the post button 1566.

The social pane 1560 includes three groups of information from the user's social network. The suggested people section 1570 identifies people that may have information that is responsive to the search query. The conversation section 1580 includes posts from the user's social network and social searching posts from the search engine. A conversation within a social network may include all posts and activities related to each other through a single activity. For example, all posts on a picture posted to a social network site may form a conversation or thread. These posts are part of a single conversation because they all related to the picture. The posts may be in response to the picture or in response to a comment on the picture. Either way, the posts are all part of a single conversation. The feed section 1590 includes items from the user's feed on their social network that may not be related to the search query 1515.

As mentioned, the suggested-people section 1570 identifies people that may have information that is responsive to the search query 1515. In this case, the search query 1515 is “hotels in Hawaii,” and Sam has been selected because he posted pictures in Hawaii. Sam's profile 1572 information is the first one displayed. Yves 1574 is selected because his profile indicates that he lived in Hawaii. Shivuka 1576 has been selected because she has a large number of followers and identifies herself as a travel blogger within her user profile. As can be seen, different factors are used to identify friends with relevant information.

In one embodiment, the suggested people are generated by matching entities within the search query, such as Hawaii, with entities within the friend's profile information and social network activity. Once a group of relevant friends is identified, they may be ranked. A threshold number of people are displayed within the suggested-people's group. In one embodiment, the ranking may be based on a degree of match between the entities in the search result and entities on the user's profile and other activities. For example, a higher degree of match could occur when the entities identified are identical. For example, Hawaii in the search result and Hawaii in Sam's profile 1572 is an exact match. A match with a higher-level entity in an entity hierarchy may result in a lower ranking. For example, Shivuka's 1576 profile expressed interest in travel, but is not specific to Hawaii or hotels.

In another embodiment, the suggested people are ranked by determining the closeness of relationship between the user and the friend. For example, a high number of interactions between the user and the friend, such as commenting on each other's posts frequently, may indicate a close relationship and indicate that the friend's input may be more highly valued. Similarly, when the user places friends into different categories, the closeness of those categories may be evaluated to determine the relevance of the person. As mentioned elsewhere, the category associated with the user may also be considered when determining how relevant the user's input might be. For example, if a user has designated a group of friends as travel club members, then the user may be particularly interested in these users' input in response to the query 1515 hotels in Hawaii. Similarly, if the query was related to hunting and the user had designated a group of users as hunting friends, then members of this group are more likely to be surfaced under the suggested people.

The conversation section 1580 includes posts from the user's social network and social searching posts from the search engine. For example, the posts may be part of the feed on the user's home page within one of their social networks. The conversation section 1580 may also include queries submitted to a search engine by members of the user's social network. As described previously, friends within a user's social network may opt into social searching, which makes their search histories available. Information from a user's search history may include queries submitted previously, comments on queries, clicks on a web page, and other information generated through the search engine. In some cases, the conversation items may appear both within the social network and originate within a user's search history.

The conversation section 1580 includes post 1582 about martinis and Lanikai, post 1584 about Obama staying in Oahu, and post 1586 about Mele Kalikimaka this year in Hawaii. As with suggested people, the posts are selected from an index of posts associated with friends within the user's social network. The posts are selected to be relevant or related to the search query. In one case, the relevance of the posts is considered high when the post asks a question related to entities within the search query. For example, the post 1582 asks a question about martinis in Lanikai. Textual analysis may be performed to determine when the post is seeking information. For example, words like who, what, when, where may indicate that information is sought. In addition, the inclusion of a question mark may also identify posts that are seeking information. As can be seen, posts 1582 and 1584 are both seeking information and are ranked ahead of post 1586 that is related to the search query but does not appear to be seeking information. As with the suggested people, the relationship between the friends that generate the posts and the user may be considered when ranking items or posts.

The feed section 1590 includes items from the user's feed on their social network. The feed for multiple social networks may be combined. The feed items may be posts, activities, or anything else from the user's feed. In one embodiment, the feed is not related to the query. Instead, the feed items, such as feed item 1592 are selected to be of present interest to the user. One factor in determining present interest is timeliness. For example, items in the feed that are not likely to have been viewed by the user yet may be included. Accordingly, the post time is one factor used to determine which feed items should be shown. Another factor is the user's previous history of interaction with particular types of feed items. For example, if the user frequently comments on new pictures added by a particular friend, then a feed item indicating new pictures had been posted by the friend is likely to show up in the feed section 1590. A user may click on the feed item and be taken to an interface that allows the user to interact with the feed item and provide additional comments. In one embodiment, clicking on the feed item brings the user to the social network site from which the feed item originated.

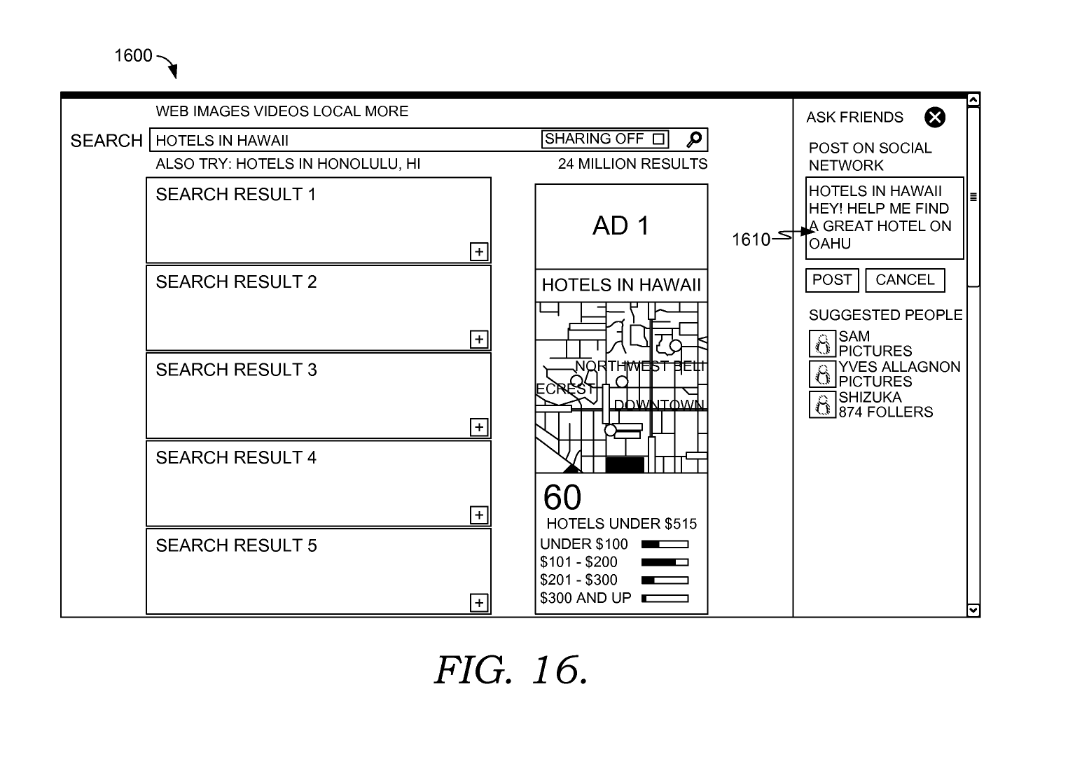

Turning now to FIG. 16, interaction with the ask friends interface 1564 is shown in accordance with an embodiment of the present invention. As can be seen, the ask friends interface 1564 has been modified to include an updated post 1610 that includes the initial search query “hotels in Hawaii” with a personalized message “Hey! Help me find a great hotel on Oahu.” The user may post this question to their social network by pushing the post button 1566. The search engine will then forward the post through the social network's application program interface (API) causing the post to show up on the user's social network feed. In one embodiment, the post is sent separately to more than one of the user's selected social networks. Though not shown, the user may be allowed to select one or more social networks to which the post is sent through the ask friends interface. The selected social networks may then be displayed as part of the interface to clarify where the post will be sent. Similarly, the ask friends interface may allow the user to select a group of friends that may see the post. The group of friends may be selected on a per social network basis or may be preselected by creating default sharing preferences through the ask friends feature.

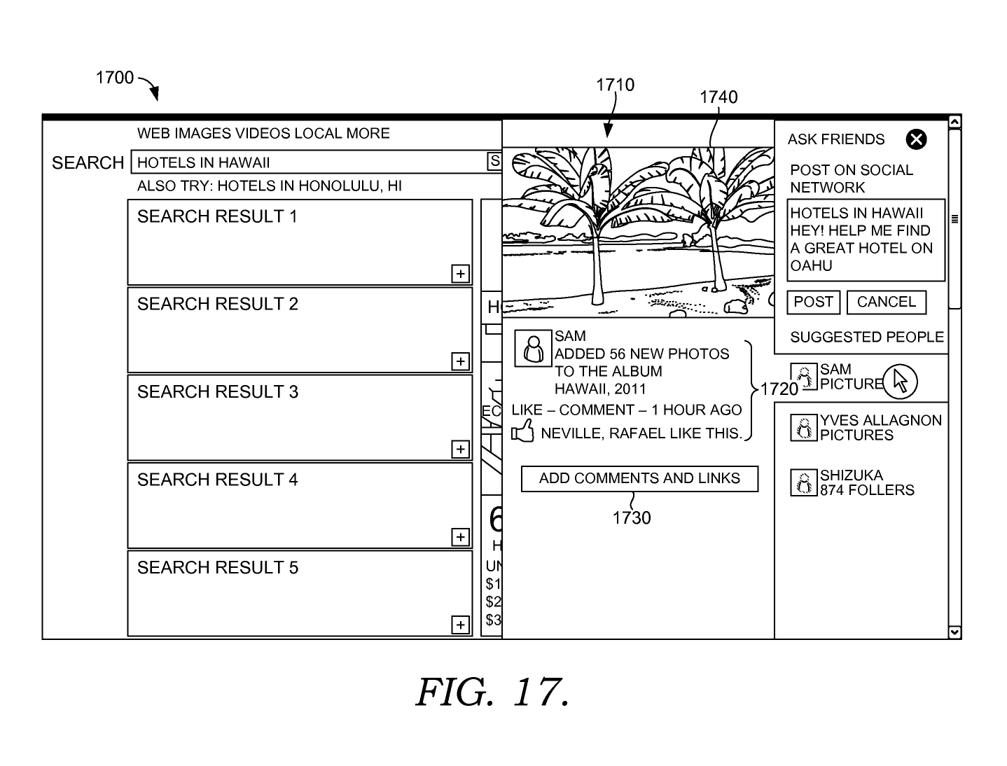

Turning now to FIG. 17, features of the suggested-people section 1570 of the social pane 1560 are illustrated, in accordance with an embodiment of the present invention. FIG. 17 shows what happens when the user clicks on the Sam profile 1572. A profile pane 1710 is displayed. The profile pane 1710 includes information about the friend that caused the friend to be displayed within the suggested-people section 1570. Here, the photo album 1740 is displayed with a button that allows the user to post comments and links on the friend's photo album, which is related to Hawaii. By pushing button 1730, the user may be taken to the social network site where Sam posted the photo album. In another embodiment, a textbox is displayed within the profile pane 1710 through which comments may be posted similar to what was described previously with the ask friends interface 1564.

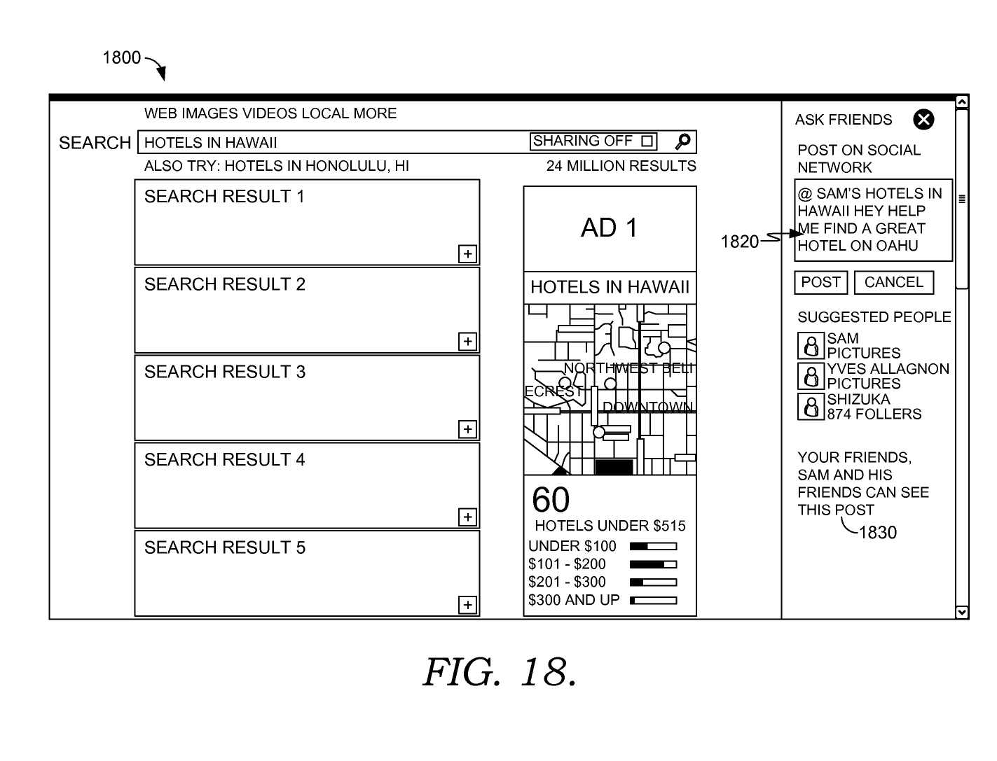

Turning now to FIG. 18, the communication of a friend specific message through the ask friends interface 1564 is shown, in accordance with an embodiment of the present invention. In this case, the ask friends post 1820 has been modified with the user I.D. for Sam. However, as the tip 1830 shows at the bottom of the pane, the ask friends post may be directed to more than just Sam. For example, the user's friends and Sam's friends may be able to see the post. In one embodiment, the post 1820 is distributed through a micro blogging site in addition to being posted on a social network website.

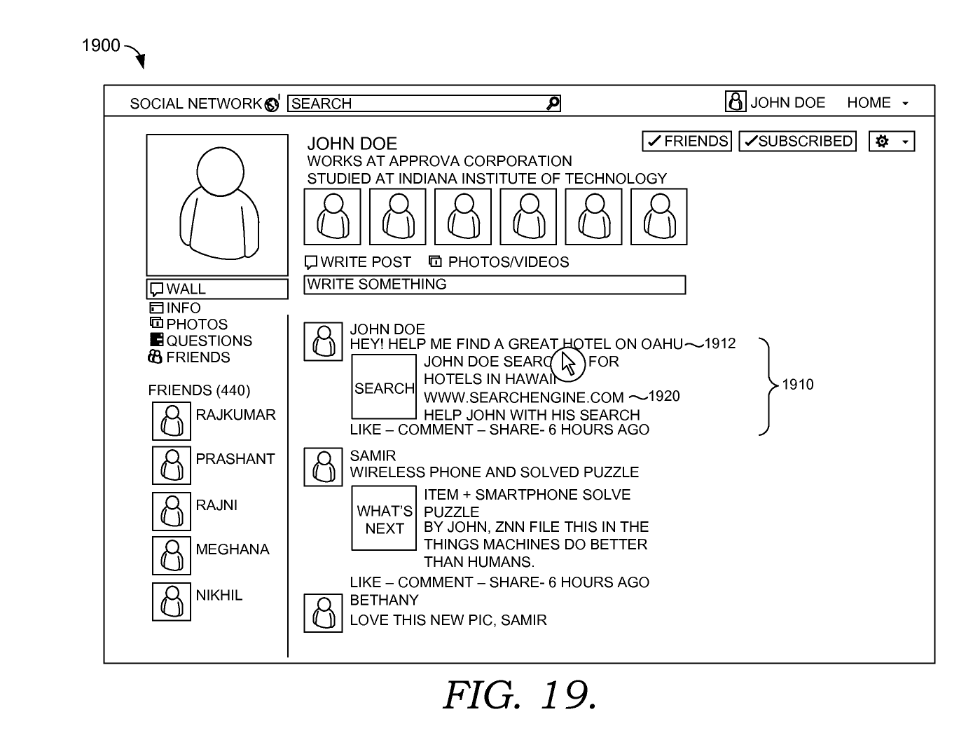

Turning now to FIG. 19, the display of an ask friends post on the user's social network home page 1900 is shown, in accordance with an embodiment of the present invention. The social network home page 1900 includes features common to the particular social network illustrated. As can be seen, the feed section includes post 1910. The post 1910 includes the text from the ask friends post 1912, the source 1920 of the post, which in this case is the search engine, and other profile information. The user or anyone that has the post 1910 within their feed may click on the source 1920 to be taken to the search engine page. The search engine page may initially show the search results and query that were displayed at the time the user posted the ask friends post.

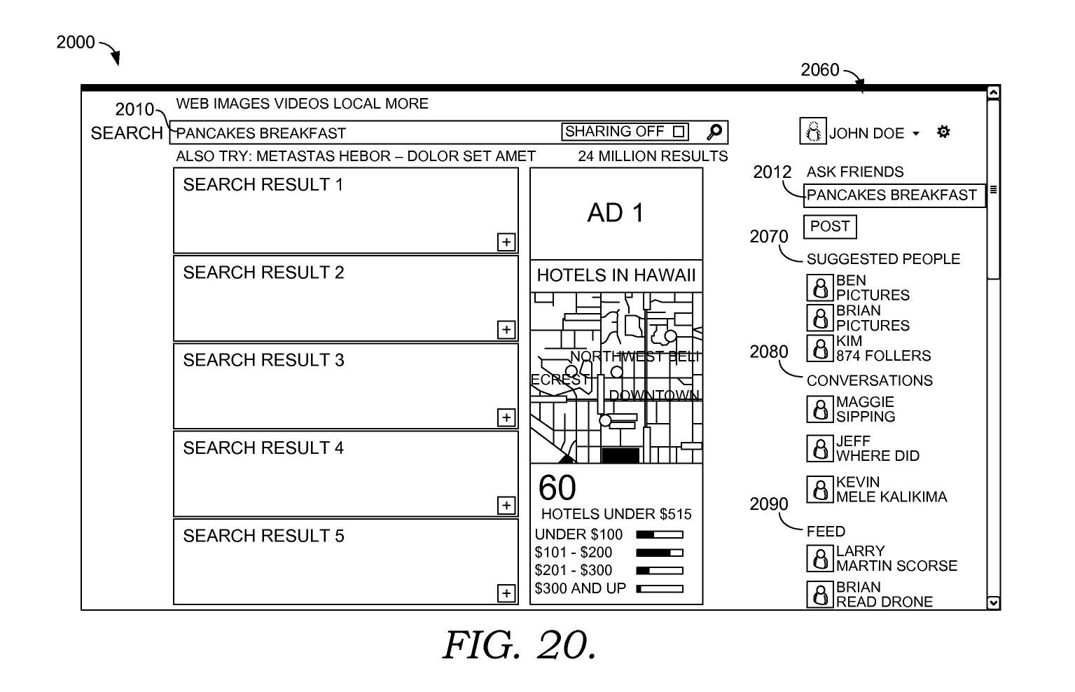

FIGS. 20-23 illustrate possible interactions with a post in the conversation section 1580, in accordance with embodiments of the present invention. FIG. 20 shows the search results page and social pane directly after the query to 2010 “pancake breakfast” was submitted. The search results will show a set of search results responsive to a pancake breakfast. The social pane 2060 includes the ask friends interface with pancake breakfast 2012 prepopulated. As compared to FIG. 16, a new set of suggested people 2070 and conversations 2080 is shown. Note that the feed within feed section 2080 is still the same. As mentioned previously, the feed items are generated independent of the query.

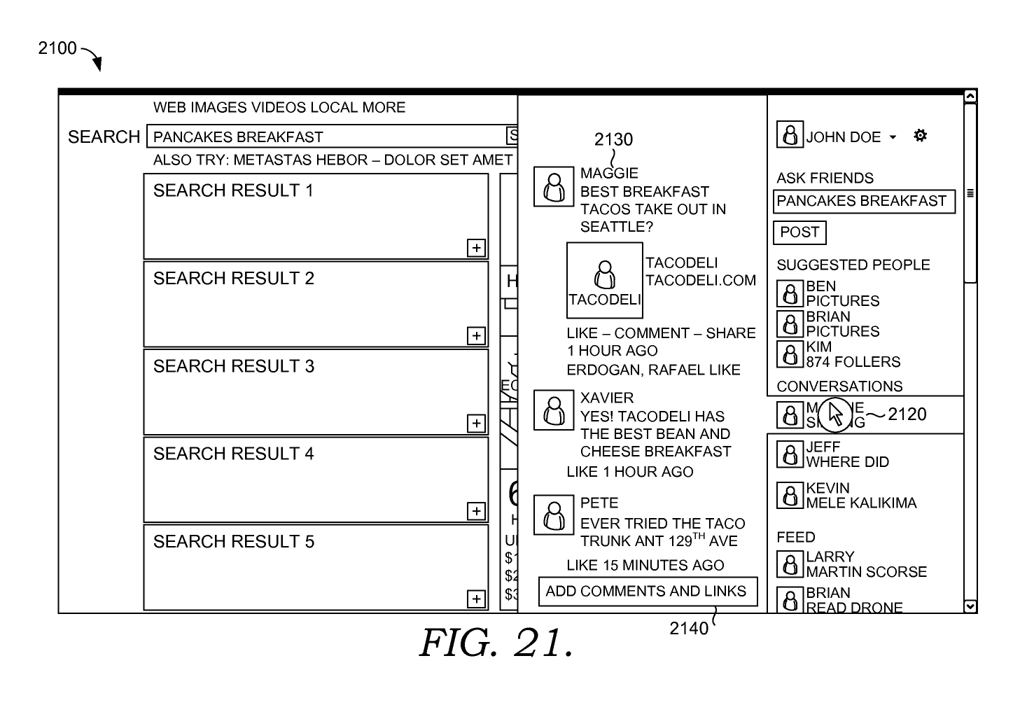

Turning now to FIG. 21, interactions with a post in the conversations section 2080 of the social pane are illustrated, in accordance with an embodiment of the present invention. As shown, the user has selected the Maggie post 2120. This opens a new post pane 2130 through which the user may interact with the Maggie post 2120. As mentioned, the Maggie post 2120 could have been generated on a social network website. Maggie is one of the user's friends. In this case, the post describes breakfast places. Comments on the post are shown below the post. The people that posted may or may not be within the user's social network. By clicking on the add comments and links button 2140, the user may post a comment on the Maggie post 2120. Any comments entered would be shown on the social network from which the Maggie post 2120 originated.

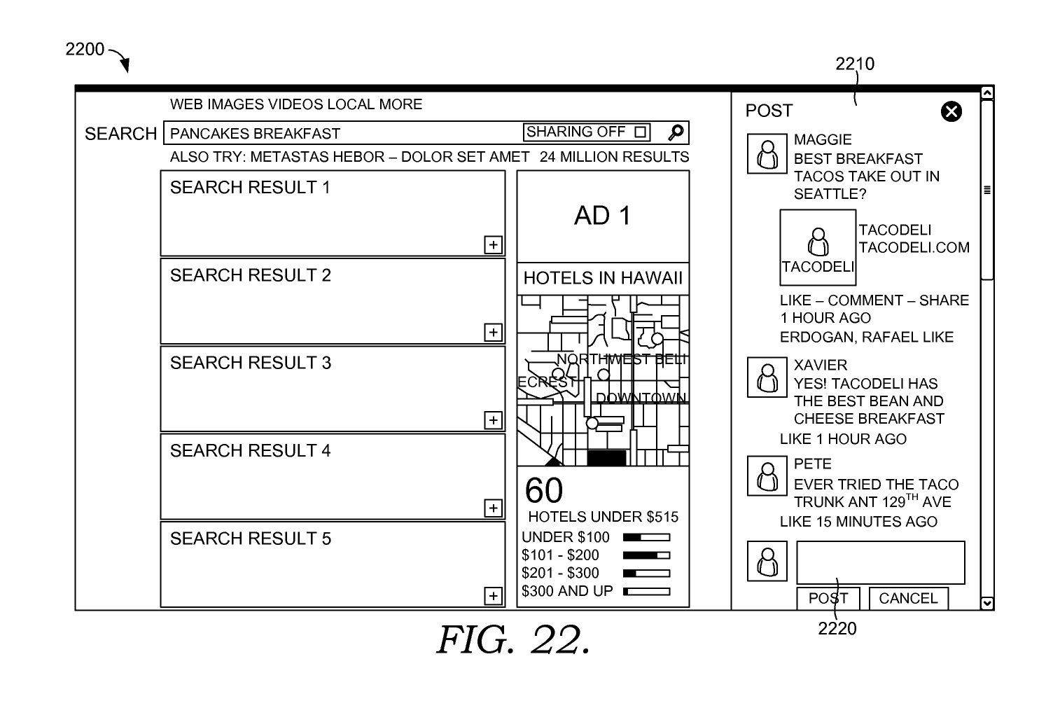

Turning now to FIG. 22, a post textbox shown in response to selecting the add comments and links button 2140 is shown, in accordance with an embodiment of the present invention. The comment pane 2210 allows the user to enter text within textbox 2220 and add a comment to the selected post. As mentioned, once posted, the comment will be shown in association with the post in the social network from which the post originated. In general, anyone who can see the comment within the social network may have access to it. In an alternative embodiment, the user may be able to select groups of people that may see the comment.

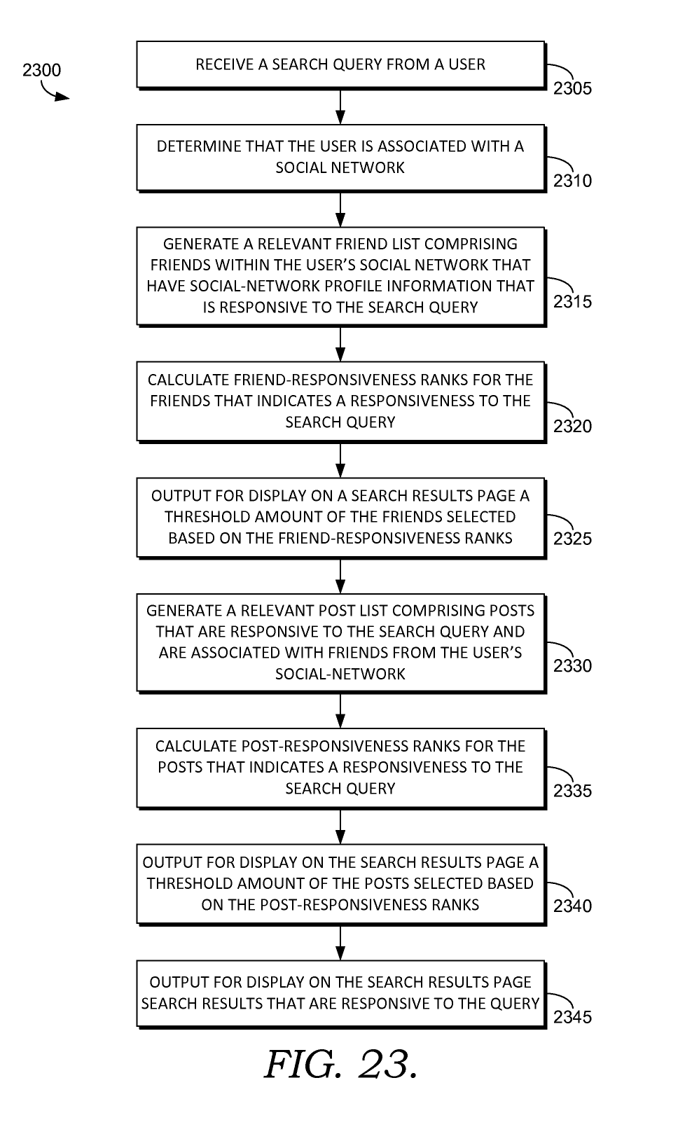

Turning now to FIG. 23, a method 2300 of providing a social-pane search enhancement that displays information from a social network is shown, in accordance with an embodiment of the present invention. The social pane may be similar to the social pane described with reference to FIG. 15. The social network may comprise a single social network or multiple social networks. Even though the term social network may be used in the singular, in embodiments it can be a group of social networks to which a user belongs. Exemplary social networks include Facebook®, LinkedIn®, and MySpace®, and others.

At step 2305, a search query is received from a user. The search query may be received through a search input box on a search engine's web page. The search query may comprise text comprising words and numbers. The search query could be submitted with a subject matter category specified. For example, the query could be submitted in the news or shopping category. The search engine may identify a user through a cookie on the user's device or because the user logged in to the search engine page, or through some other mechanism.

At step 2310, it is determined that the user is associated with a social network. The user may have linked their search engine user ID to the social network identifications of one or more social networks. Again, they could be a member of multiple social networks, each with a unique identification.

At step 2315, a relevant friend list comprising friends within the user's social network is generated. The relevant friend list comprises friends that have social-network profile information that is responsive to a search query. The relevant friends may be identified by analyzing an index of profile information associated with the user's friends to find commonalities. Search history information, when available, captured by the search engine can also be analyzed to determine relevant friends. Individual searches may need to be conducted across multiple social websites that are part of the user's social network. A user's social-network profile information may be responsive to the query because it includes entities that match entities in the query. An entity match occurs when the same word occurs in the query and in the profile. However, the term entities is used to clarify that the search match does not need to be word for word. For example, a query for a Ford Mustang includes the entities Ford and Mustang. This could match with the term car, which would be a broader term, within a user's profile. Using entities allows for terms in a search query to be generalized to enable matches at different levels of an entity hierarchy even though the terms are not the same.

At step 2320, a friend-responsiveness rank for the friends is calculated. The friend-responsiveness rank indicates a relative responsiveness to the search query. The rank may be a stack rank of the friends' degree of responsiveness to the search query. As mentioned previously, many factors may be weighed to arrive at the friend-responsiveness rank. For example, the type of relationship indicated within the user's social network may be considered. Users with a closer relationship may be considered more relevant. Similarly, users categorized by interest group may be considered more relevant when the query seems to fall within the scope of that interest. Additionally, when multiple separate social websites are within the user's social network, the frequency of interaction with a particular social network may be considered to give more weight to friends within that social network.

At step 2325, a threshold amount of friends selected based on the friend-responsiveness ranks are output for display on a search results page. As mentioned previously, they may be output within a social pane on the search results page. For example, in FIG. 15, the friends may be output in the suggested people section 1570.

At step 2330, a relevant post list that comprises posts that are responsive to the search query is generated. The posts are associated with friends from the user's social network. A post is relevant when it contains entities that match entities in the query. As mentioned previously, the entities may be generalized to find a match.

At step 2335, post-responsiveness ranks are calculated for the posts. The ranks indicate a relative responsiveness to the search query. Factors that increase a post rank include posts that are seeking information. A post may be determined to be seeking information through a textual analysis. The textual analysis may identify a question mark or words associated with seeking information (e.g., who, what, when, where). A high ranking may be assigned to a post that has the object of the inquiry matching the object of the query.

At step 2340, a threshold amount of the posts are output for display on the search result page. The posts that are output are selected based on the post-responsiveness ranks. The posts may be output for display within a social pane, as described previously.

At step 2345, search results are output for display on the search results page. As indicated previously, the search results are displayed along with the posts and friends that have been described previously. As mentioned previously, the user may interact with the friends and posts that are output in addition to the search results. Interactions include selecting a post to comment on the post. When commenting on a post or directing a question to a friend that has surfaced on the search results page, the comment may be communicated to a social network from which the post or friend originated.

In addition to the posts and people that are displayed on the search results page, feed items may also be displayed. The feed items may be selected without considering responsiveness to the query. Instead, the feed items may be selected based on a likelihood that the user will interact with the feed item or be interested in the feed item.

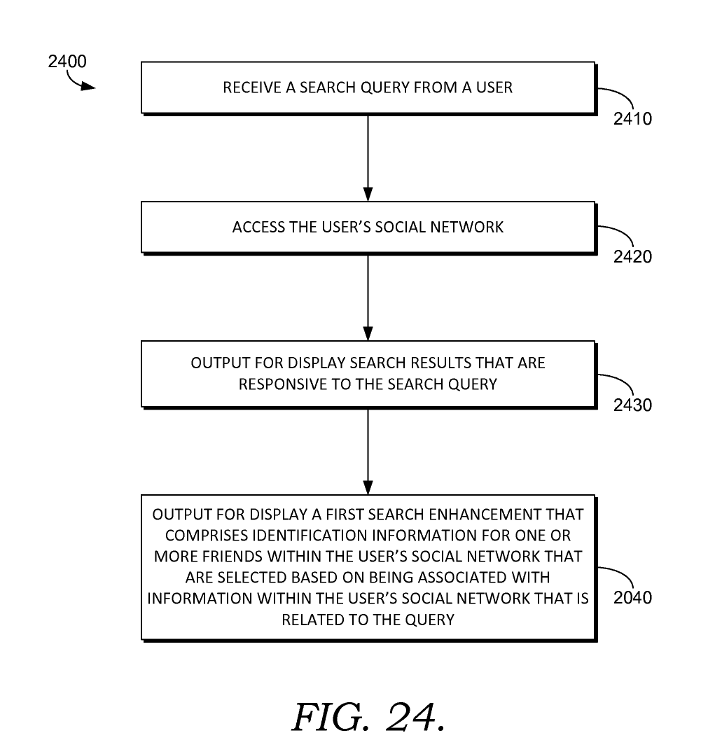

Turning now to FIG. 24, a method 2400 of providing, on a search results page, search enhancements that are based on a user's social network are shown, in accordance with an embodiment of the present invention. At step 2410, a search query is received from a user. As mentioned previously, the search query may be input on a search engine's home page through a query input box.

At step 2420, the user's social network is accessed. The user's social network may be accessed through an application program interface provided by the one or more social networks that comprise the user's social network. The search engine may supply credentials to the one or more social networks that allow the search engine to access the user's social network feed or other data associated with the social network. In one embodiment, the search engine provides the user's social network ID and password to the social network in order to post information to the user's account on the social network or to retrieve information.

At step 2430, search results that are responsive to the search query are generated and output for display on the search results page.

At step 2440, a first search enhancement that comprises identification information for one or more friends within the user's social network that are selected based on being associated with information within the user's social network is output for display. As mentioned previously, the friends that are output for display are determined to be related to the query. Methods of relating friends to the query have been described previously. These methods may use information about the friends gathered from the search engine and the friends' search histories, as well as information accessed via the user's social network. The combined analysis of information from the user's search histories and social network may be used to determine the friends' potential relevance to the query. For example, an entity match between entities in the query and an entity's profile or social network activity may be used to determine that the friend has information responsive to the query. Similarly, a search history that includes related queries or topics may indicate the user or friend are searching or have searched for similar information.

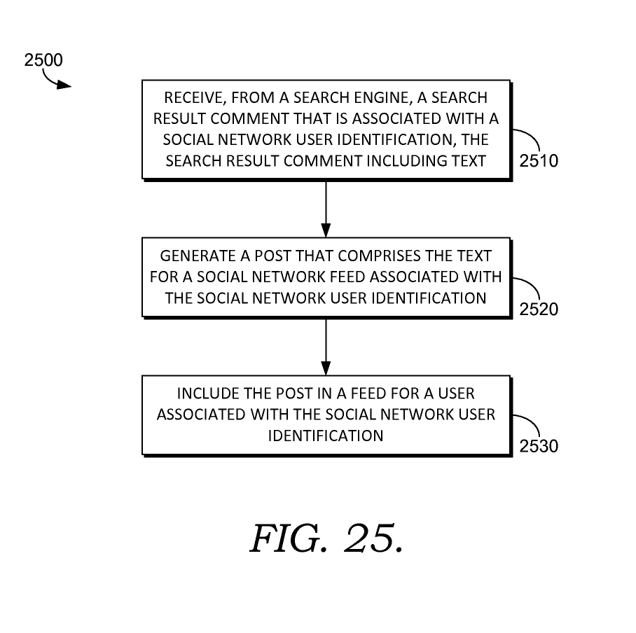

Turning now to FIG. 25, a method 2500 of including information in a social network feed that was generated on a search results page is shown, in accordance with an embodiment of the present invention. The search results page may be associated with an online search engine. A social network feed may be associated with a particular user. Though associated with a particular user, aspects of the feed may be published to the user's friends within the social network. In another embodiment, only select friends are able to see the information posted to the social network from the search engine.

At step 2510, a search result comment is received from a search engine. The search result comment is associated with a social network user identification. The search result comment includes text. The search result comment is received by a social network and may be formatted in a particular manner to conform with the social network's application program interface. The search result comment may also include an identification of a search result record that is maintained by the search engine. This allows a user to select the search result comment from the social network and be transported to the search results page generated by the original query.

At step 2520, a post that comprises the text for a social network feed associated with the social network user identification is generated. The post may comprise an icon identifying the search engine, user information, a query text, a comment text, and a link to the search engine. Further, an ability to comment or provide feedback on the post may be included within the post. Generally, information included on posts within the social network may be included in the post generated based on the search result comment.

At step 2530, the post is included in a feed for the user associated with the social network user identification. Once in the feed, the post may be visible on a user's social network home page as well as in the feed of friends that subscribe to the user's feed. The subscription information may be maintained by the user within the social network or specified on the search results page.

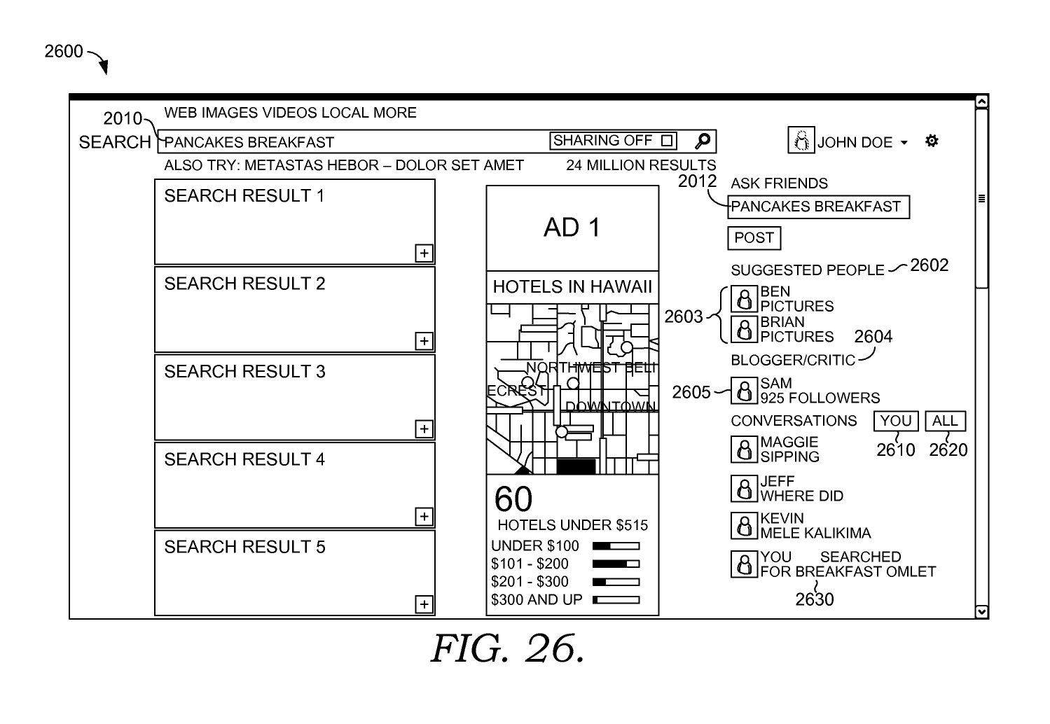

Turning now to FIG. 26, a tabbed conversations section is illustrated according to an embodiment of the present invention. The search results page 2600 is similar to those described previously. The suggested people section 2602 displays two friends 2603 that may know about pancake breakfasts. In addition, the search enhancement section includes a blogger/critic section 2604. This section shows a blogger/critic 2605 that may have information related to the search query. The blogger may be selected in the same way friends are 2603 are selected. Bloggers/critics may be identified through their user profile, through a registry, or automatically identified based on activities within the social network. For example, a person may be categorized as a blogger if they post above a threshold number of comments within a time period, post above a threshold number of posts having greater than a threshold amount of text, and/or have above a threshold number of followers. In one embodiment, the blogger critic is not part of the user's social network. A blogger may be selected for inclusion based on expertise in the query's subject matter. Further, a blogger may be selected when the blogger/critic is liked by or followed by the user's friends, even if not followed by the user. The total number of followers may also be considered when selecting a blogger/critic. The more followers the more likely the blogger is to be included.

The conversations section allows the user to tab between different categories of activities by selecting the “you” tab 2610 or the “all” tab 2620. The “you” tab 2610 limits the activities displayed to those occurring in conversations in which the user has participated. For example, if the user commented on a friend's post, then activities related to the friend's post could be included when the “you” tab is active. The user's own activities may also be displayed. For example, activity 2630 links to one of the user's previous searches related to breakfast. Selecting the “all” tab 2620 removes allows all relevant conversation activities to be displayed. Methods for selecting and ranking the activities, in either tab, have been described previously.

As can be understood, embodiments of the present invention provide an enhanced search experience using search history information from a group of one or more friends. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-storage media having computer-executable instructions embodied thereon for performing a method of providing a social-pane search enhancement that displays information from a social network, the method comprising:
receiving a search query from a user;
determining that the user is associated with a social network;
generating a relevant friend list comprising friends within the user's social network that have social-network profile information that is responsive to the search query;
calculating friend-responsiveness ranks for the friends that indicate a responsiveness to the search query;
outputting for display on a search results page a threshold amount of the friends selected based on the friend-responsiveness ranks;
generating a relevant post list that comprising posts that are responsive to the search query and are associated with friends from the user's social network;
calculating post-responsiveness ranks for the posts that indicate a responsiveness to the search query;
outputting for display on the search results page a threshold amount of the posts selected based on the post-responsiveness ranks; and
outputting for display on the search results page search results that are responsive to the search query.

2. The one or more computer-storage media of claim 1, wherein the method further comprises:
generating a relevant feed list comprising items in the user's social network feed without considering whether the items are responsive to the search query;
calculating interaction ranks for the items that indicate a likelihood that the user will interact with an individual item; and
outputting for display on the search results page a threshold amount of the items selected based on the interaction ranks.

3. The one or more computer-storage media of claim 2, wherein an interaction rank for an individual feed item increases when the individual feed item is associated with a trending topic.

4. The one or more computer-storage media of claim 1, wherein the post-responsiveness rank is increased when an individual post is seeking information.

5. The one or more computer-storage media of claim 1, wherein the relevant friend list is generated by obtaining a list of friends from the user's social network and then evaluating information from the social network and from a search history to identify commonalities between the information and the search query.

6. The one or more computer-storage media of claim 1, wherein the method further comprises outputting for display an ask friends interface that receives a comment that is communicated to the user's social network.

7. The one or more computer-storage media of claim 7, wherein the search query is automatically added to the ask friends interface as a starting point for the comment.

8. A method of providing, on a search results page, search enhancements that are based on a user's social network, the method comprising;
receiving a search query from a user;
accessing the user's social network;
outputting for display search results that are responsive to the search query; and
outputting for display a first search enhancement that comprises identification information for a friend within the user's social network that is selected because entities within the friend's social network profile are responsive to the search query.

9. The method of claim 8, wherein the user's social networks comprise multiple social networking websites.

10. The method of claim 8, wherein the friend is selected because of an activity within the social network that is related to the search query.

11. The method of claim 10, wherein the entity is one or more of where a friend lives, where a friend attended college, and information posted by the friend.

12. The method of claim 8, wherein the friend is selected because of a search within the friend's search history that is related to the search query.

13. The method of claim 8, wherein the method further comprises outputting for display a second search enhancement comprising a post from the user's social network.

14. The method of claim 13, wherein the post is selected because the post is seeking information related to the search query.

15. The method of claim 13, wherein the method further comprises outputting for display an interface through which the user can add a comment to the post and communicating the comment to the user's social network.

16. The method of claim 8, wherein the method further comprises outputting for display a third search enhancement comprising items from a feed within the user's social network that are selected without consideration of the search query and by calculating a probability that the user will interact with a feed item using past search activity and past social network activity.

17. One or more computer-storage media having computer-executable instructions embodied thereon for performing a method of including information in a social network feed that was generated on a search results page, the method comprising:
receiving, from a search engine, a search result comment that is associated with a social network user identification, the search result comment including text;
generating a post that comprises the text for a social network feed associated with the social network user identification; and
including the post in a feed for a user associated with the social network user identification.

18. The one or more computer-storage media of claim 17, wherein the post includes a link to a search results page on which search results related to the search comment were generated.

19. The one or more computer-storage media of claim 17, wherein the method further comprises receiving a comment on the post from an additional user of the social network, including the comment in the feed for the user, and communicating the comment to the search engine.

20. The one or more computer-storage media of claim 17, wherein the method further comprises receiving, from the search engine, a comment on a post that originates in the social network and including the comment in a comment thread for the post.
